(19) United States
(12) Patent Application Publication
(10) Pub. No.: US 2026/0151743 A1
(43) Pub. Date: Jun. 4, 2026

(54) UREMIC METABOLITE-ZWITTERIONIC HEMOCOMPATIBLE DIALYSIS MEMBRANES

(71) Applicant: University of Saskatchewan, Saskatoon (CA)

(72) Inventors: Amira Abdelrasoul, Saskatoon (CA); Arash Mollahosseini, Saskatoon (CA); Ahmed Said A-H Shoker, Saskatoon (CA)

(21) Appl. No.: 19/125,382

(22) PCT Filed: Nov. 1, 2023
(86) PCT No.: PCT/CA2023/051458

§ 371 Date: Apr. 29, 2025

Related U.S. Application Data
(60) Provisional application No. 63/421,314, filed on Nov. 1, 2022.

(51) Int. Cl. B01D 67/00; B01D 61/24; B01D 69/02; B01D 71/68

(52) U.S. Cl. CPC B01D 67/00931; B01D 61/243; B01D 69/02; B01D 71/68; B01D 2325/18

(57) ABSTRACT

The present disclosure is directed to hemodialysis membranes. In particular, the present disclosure relates to hemodialysis membranes comprising uremic metabolites and zwitterionic moieties, and methods of hemodialysis thereof.

### RELATED APPLICATION

This application claims the benefit of U.S. Provisional Application No. 63/421,314 filed Nov. 1, 2022; the entire content of U.S. Patent Application No. 63/421,314 is hereby incorporated by reference.

### FIELD

The present disclosure is directed to hemodialysis membranes. In particular, the present disclosure relates to hemodialysis membranes comprising uremic metabolites and zwitterionic moieties, and methods of hemodialysis thereof.

### INTRODUCTION

Hemodialysis is a life-sustaining procedure for patients with end-stage renal disease (ESRD). The efficiency of hemodialysis is limited by the dialysis membrane biocompatibility and the poor clearance of middle-molecule uremic toxins. As a result, hemodialysis is associated with acute chronic side-effects that threaten patients' lives. During hemodialysis, interfacial interactions of blood-polymeric membranes result in several consequences. These interactions lead to the body's various system activations, including the coagulation of blood components, leukocytes (i.e., immune system activation) and complement activations, thrombogenesis, cytokine production, and appearance of radicals with free oxygen. Despite advances in research, the most vital issue in dialysis therapies is the biocompatibility and hemo-incompatibility of the membranes. The process of enhancing membrane hemocompatibility is currently posing a global challenge. Reactions to incompatibility can cause severe injuries to the patients and result in morbidity and mortality.

A major weakness of current membranes is that blood-membrane interactions activate blood cells such as leukocytes (Leu), platelets (PLT), and red blood cells (RBCs) or indirectly activate them through the pathway that activates the complement system or coagulation factors¹¹⁻¹³. A common approach is hydrophilic modification of the membrane to improve the hemocompatibility. However, enhancing the hydrophilicity of the membrane surface leads to dehydration of the blood stream and induces the rupture of RBCs^{11,27}. Moreover, determining the adsorption profile of different proteins does not offer any valuable knowledge to improve the membranes due to competitive protein adsorption to the membrane surface by blood serum proteins (the Vroman effect).

### SUMMARY

The present disclosure is directed to a hemodialysis membrane material with improved hemocompatibility and reduced fouling. In particular, the present disclosure includes a hemodialysis membrane material having the following structure:

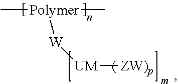

wherein,
Polymer is a membrane material polymer;
n is an integer which represents the degree of polymerization and the number of repeating monomer units of the polymer and is between 1 and 1,000,000;
W is an optional linker moiety that contains functional groups including hydroxyl carboxyl, amine, amine, ether, imine, isocyanate, azo compounds, carboxylic acid, ester, and ketone;
UM is a uremic metabolite moiety;
ZW is a zwitterionic moiety;
p is 1, 2 or 3; and
m is 1, 2 or 3.

In another embodiment, the present disclosure includes a hemodialysis membrane material having the following structure

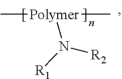

wherein,
n is an integer which represents the degree of polymerization and the number of repeating monomer units of the polymer and is between 1 and 1,000,000;
R₁ is a moiety comprising a zwitterionic moiety; and
R₂ is H, (C₁-C₁₀)-alkyl, or a moiety comprising a zwitterionic moiety.

The present disclosure also includes a method for dialysis or hemofiltration comprising contacting blood from a patient in need of dialysis with a membrane comprising the hemodialysis membrane material.

Other features and advantages of the present application will become apparent from the following detailed description. It should be understood, however, that the detailed description and the specific examples while indicating preferred embodiments of the application are given by way of illustration only, since various changes and modifications within the spirit and scope of the application will become apparent to those skilled in the art from this detailed description.

### BRIEF DESCRIPTION OF THE DRAWINGS

The present disclosure will now be described in greater detail with reference to the drawings in which:

FIG. 1 is a schematic representation of a reaction to prepare a membrane material in one embodiment of the present disclosure.

FIG. 2 is a schematic representation of a reaction to prepare a membrane material in another embodiment of the present disclosure.

FIG. 3 is a schematic representation of a reaction to prepare a membrane material in one embodiment of the present disclosure.

FIG. 4 is a schematic representation of a reaction to prepare a membrane material in another embodiment of the present disclosure.

FIG. 5 is a hypothetical schematic representation of a reaction to prepare a membrane material in another embodiment of the present disclosure.

FIG. 6 is a FT-IR spectrum of (a) PES and (b) PES-NH₂ membranes in one embodiment of the disclosure.

FIG. 7 is a ATR-FTIR comparison of PES and PES-NH₂-TCT membranes in one embodiment of the present disclosure.

FIG. 8 is a ATR-FTIR comparison of PES and PES-NH₂-TCT-DMPD membrane in one embodiment of the present disclosure.

FIG. 9 shows a (a) N 1s XPS wide-angle scan of the PES-UM-CB; and (b) N 1s XPS wide-angle scan of the PES-UM-CB membrane in one embodiment of the present disclosure.

FIG. 10 shows a (a) N 1s XPS wide-angle scan of the PES-UM-SB membrane; (b) O 1s XPS scan of the PES-UM-SB membrane; and (c) S 2p XPS scan of the PES-UM-SB membrane in one embodiment of the present disclosure.

FIG. 11 shows AFM scans of UM-ZW membranes; (a) top view of PES-UM-SB, (b) 3D view of PES-UM-SB, (c) top view of PES-UM-CB, and (d) 3D view of PES-UM-CB in one embodiment of the present disclosure.

FIG. 12 shows a SEM micrograph of neat and modified membranes; (a) neat PES, (b) PES-UM-CB, and (c) PES-UM-SB in one embodiment of the present disclosure.

FIG. 13 shows surface charge of neat and chemically modified membranes in one embodiment of the present disclosure.

FIG. 14 shows a nitrogen adsorption isotherm for (a) neat PES, (b) PES-TCT-DMPD, (c) PES-UM-CB, and (d) PES-UM-SB in one embodiment of the present disclosure.

FIG. 15 shows a DSC peak of neat and PES-ZW membrane; (a) neat PES, (b) PES-UM-CB, (c) PES-UM-SB in one embodiment of the present disclosure.

FIG. 16 shows a ATR-FTIR characterization of neat and GNDM-SB functionalized membrane in one embodiment of the present disclosure.

FIG. 17 shows AFM scans of (a) GNDM-assisted amine functionalized PES membrane, and (b) PES-GNDM-SB membrane in one embodiment of the present disclosure.

FIG. 18 shows surface charge variation PES membrane through different functionalization steps in one embodiment of the present disclosure.

FIG. 19 shows DSC scans of the neat and treated PES membranes; (a) neat PES, (b) PES-directGNDM-SB in one embodiment of the present disclosure.

FIG. 20 shows Zwitterionic modifications for PES hemodialysis membranes, (a) PES-CB, (b) PES-SB, (c) PES-directGNDM-CB, (d) PES-directGNDM-SB, (e) PES-GNDM-CB, and (f) PES-GNDM-SB in one embodiment of the present disclosure.

FIG. 21 shows PF4 concentration after incubating blood with neat and modified PES membranes in one embodiment of the present disclosure.

### DESCRIPTION OF VARIOUS EMBODIMENTS

### Definitions

Unless otherwise indicated, the definitions and embodiments described in this and other sections are intended to be applicable to all embodiments and aspects of the present application herein described for which they are suitable as would be understood by a person skilled in the art.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

As used in the present application, the singular forms “a”, “an” and “the” include plural references unless the content clearly dictates otherwise. For example, an embodiment including “a compound” should be understood to present certain aspects with one compound, or two or more additional compounds.

In embodiments comprising an “additional” or “second” component, such as an additional or second compound, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present. The term “and/or” with respect to enantiomers, prodrugs, salts and/or solvates thereof means that the compounds of the application exist as individual enantiomers, prodrugs, salts and hydrates, as well as a combination of, for example, a salt of a solvate of a compound of the application

The term “membrane material polymer” as used herein refers to a membrane material or a polymer which is hemocompatible with patients blood, such polymer having a reduced blood activation and a decreased thrombotic response when it comes in contact with patients blood.

The term “(C₁-Cₚ)-alkyl” as used herein means straight and/or branched chain, saturated alkyl radicals containing from one to “p” carbon atoms and includes (depending on the identity of p) methyl, ethyl, propyl, isopropyl, n-butyl, s-butyl, isobutyl, t-butyl, 2,2-dimethylbutyl, n-pentyl, 2-methylpentyl, 3-methylpentyl, 4-methylpentyl, n-hexyl and the like, where the variable p is an integer representing the largest number of carbon atoms in the alkyl radical.

The suffix “ene” added on to any of the above groups (e.g. alkylene) means that the group is divalent, i.e. inserted between two other groups.

The term “uremic metabolite moiety” as used herein refers to uremic metabolites which are the products of protein metabolism, and which can be classified according to physiochemical properties especially with regard to molecular size and protein binding. Uremic metabolite moieties can be biologically active compounds and are organic or inorganic moieties.

The term “zwitterionic moiety” as used herein refers to a moiety that is electrically neutral and contains an equal number of positively charged and negatively charged functional groups or a material that carries formal positive and negative charges on different atoms.

### Hemocompatible Membrane Material

In one embodiment of the disclosure, there is included a hemodialysis membrane material having the following structure:

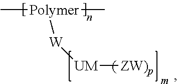

wherein,
Polymer is a membrane material polymer;
n is an integer which represents the degree of polymerization and the number of repeating monomer units of the polymer and is between 1 and 1,000,000;
W is an optional linker moiety that contains functional groups including hydroxyl carboxyl, amine, amine, ether, imine, isocyanate, azo compounds, carboxylic acid, ester, and ketone;
UM is a uremic metabolite moiety;
ZW is a zwitterionic moiety;
p is 1, 2 or 3; and
m is 1, 2 or 3.

In one embodiment, the integer n is a number between 1 and 100,000, or 1 and 50,000, or 1 and 10,000.

In one embodiment, the polymer is polysulfone, polyether sulfone, polyether ketone, polyvinyl fluoride, cellulose acetate, cellulose di-acetate, cellulose tri-acetate, polyvinyl chloride, polyurethane, polypropylene, high density polyethylene, high density polyethylene, poly carbonate, natural rubber, acryl butadiene styrene, polyamide, polyacrylate, poly(methyl methacrylate), or polyacrylonitrile.

In one embodiment, W is absent, NH, —(C₁-C₁₀)-alkylene, or —(C₁-C₁₀)-alkylene-phenyl.

In one embodiment, the membrane material has the following structure:

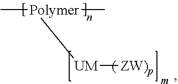

wherein,
Polymer is polysulfone;
UM is a uremic metabolite moiety;
ZW is a zwitterionic moiety;
n is an integer which represents the degree of polymerization and the number of repeating monomer units of the polymer and is between 1 and 1,000,000;
p is 1, 2 or 3; and
m is 1, 2 or 3.

In one embodiment, the membrane material has the following structure:

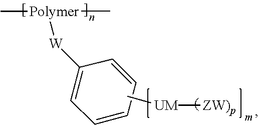

wherein,
Polymer is polysulfone;
W is absent, —(C₁-C₁₀)-alkylene or NH;
UM is a uremic metabolite moiety;
ZW is a zwitterionic moiety;
p is 1, 2 or 3; and
m is 1, 2 or 3.

In another embodiment, the polymer is

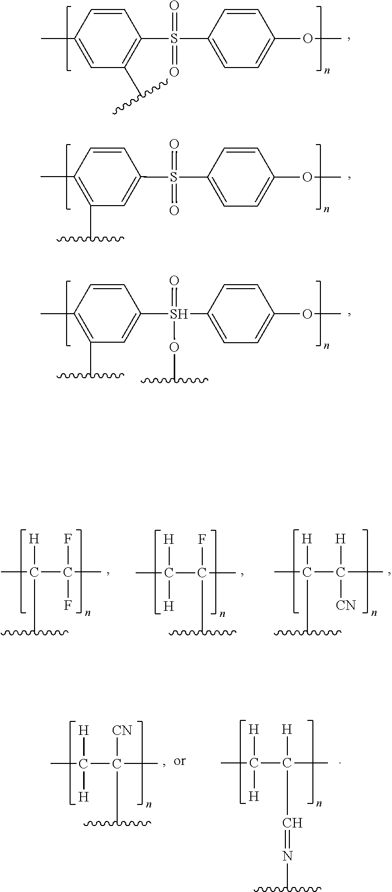

In one embodiment, the membrane material has the structure

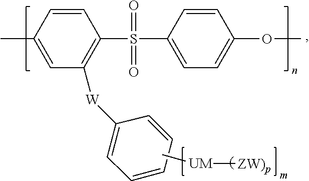

wherein
W is absent, —(C₁-C₁₀)-alkylene or NH;
UM is a uremic metabolite moiety;
ZW is a zwitterionic moiety;
p is 1, 2 or 3; and
m is 1, 2 or 3.

In another embodiment, the uremic metabolite moiety is a product of protein metabolism.

In another embodiment, the uremic metabolite moiety comprises one of the following moieties:
(a) a guanidine moiety

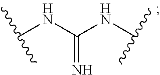 [SMILES: *NC(=N)N*]

(b) a urea moiety

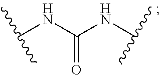 [SMILES: *NC(=O)N*]

(c) a phenol moiety

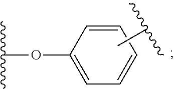

(d) an indole moiety

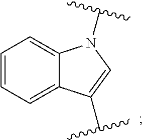 [SMILES: *c1cn(*)c2ccccc12]

(e) a polyamine moiety

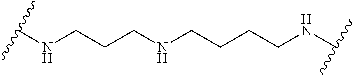 [SMILES: *NCCCCNCCCN*]

(f) a glucose moiety

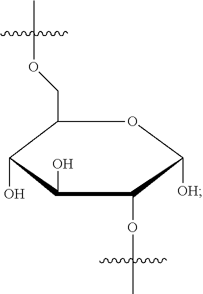

(g) a Hippurate moiety

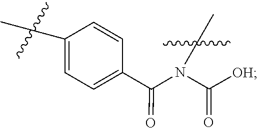 [SMILES: *c1ccc(C(=O)N(*)C(=O)O)cc1]

(h) a polyhydric alcohol moiety

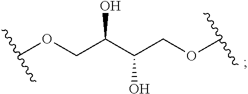 [SMILES: *OC[C@@H](O)[C@@H](O)CO*]

(i) an inosine moiety

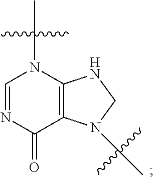 [SMILES: *N1CNc2c1c(=O)ncn2*]

(j) an oxalate moiety

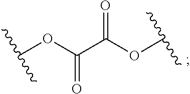 [SMILES: *OC(=O)C(=O)O*]

(k) a phenylactic acid moiety

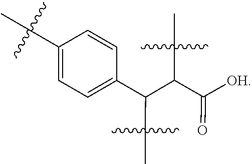 [SMILES: *c1ccc(C(*)C(*)C(=O)O)cc1]

In another embodiment, the guanidine moiety is guanidine, creatinine, creatine, guanidinobutyric acid, Dimethylarginine, Guanidinopropionic acid, Guanidinoacetic acid, Guanidinosuccinic acid, Methylguanidine, Alpha-keto-delta-guanidinoacetic acid, Argininic acid, alpha N-acetylarginine, Taurocyamine, Pentosidine, Adrenomedullin, Atrial natriuretic peptide, Cystatin C, 1-methylguanosine, Neuropeptide Y, beta-lipotropin, N2,N2-dimethylguanosine, Leptin, β2-microglobulin, or Parathyroid hormone.

In another embodiment, the guanidine moiety has the structure

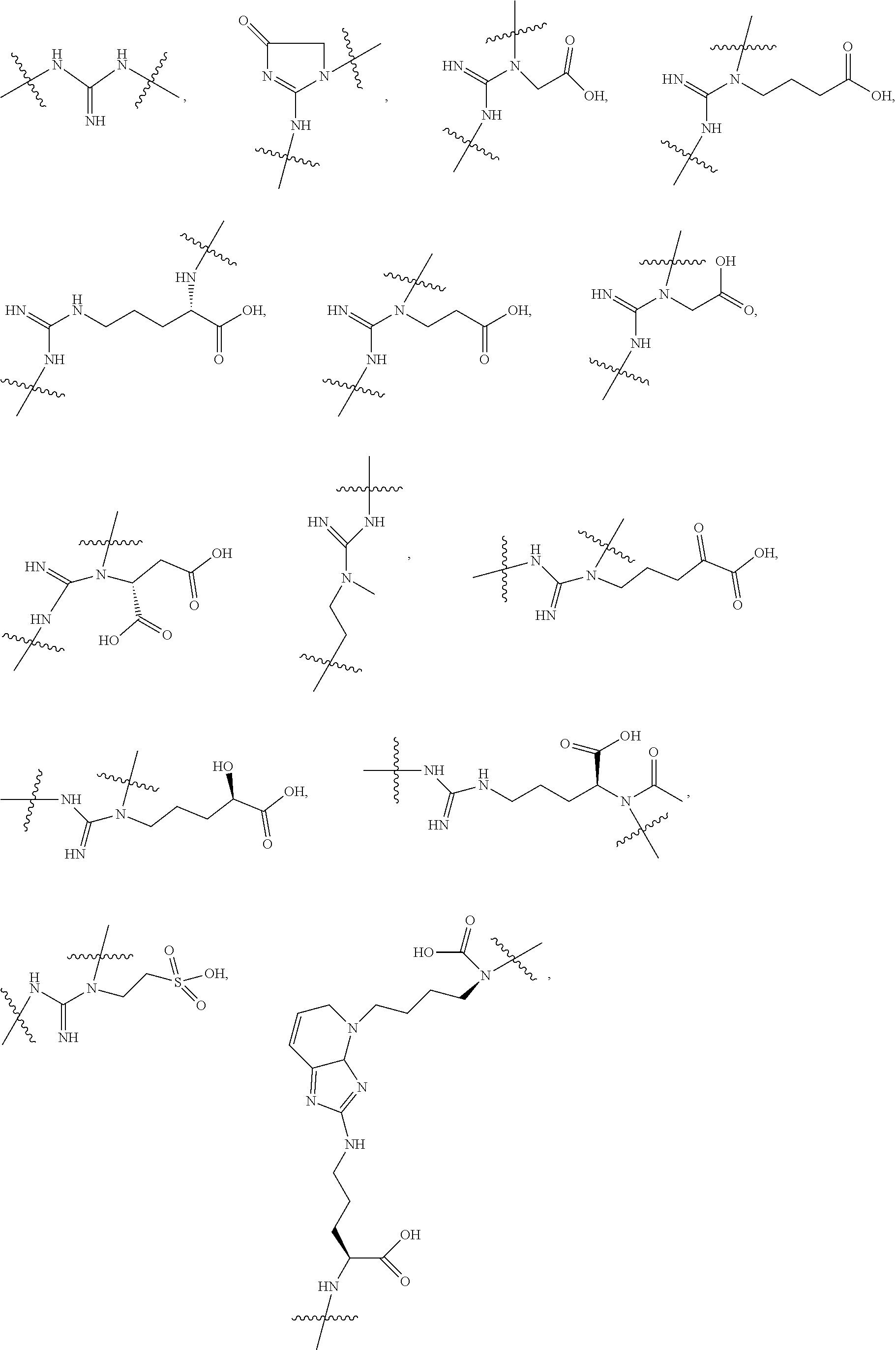

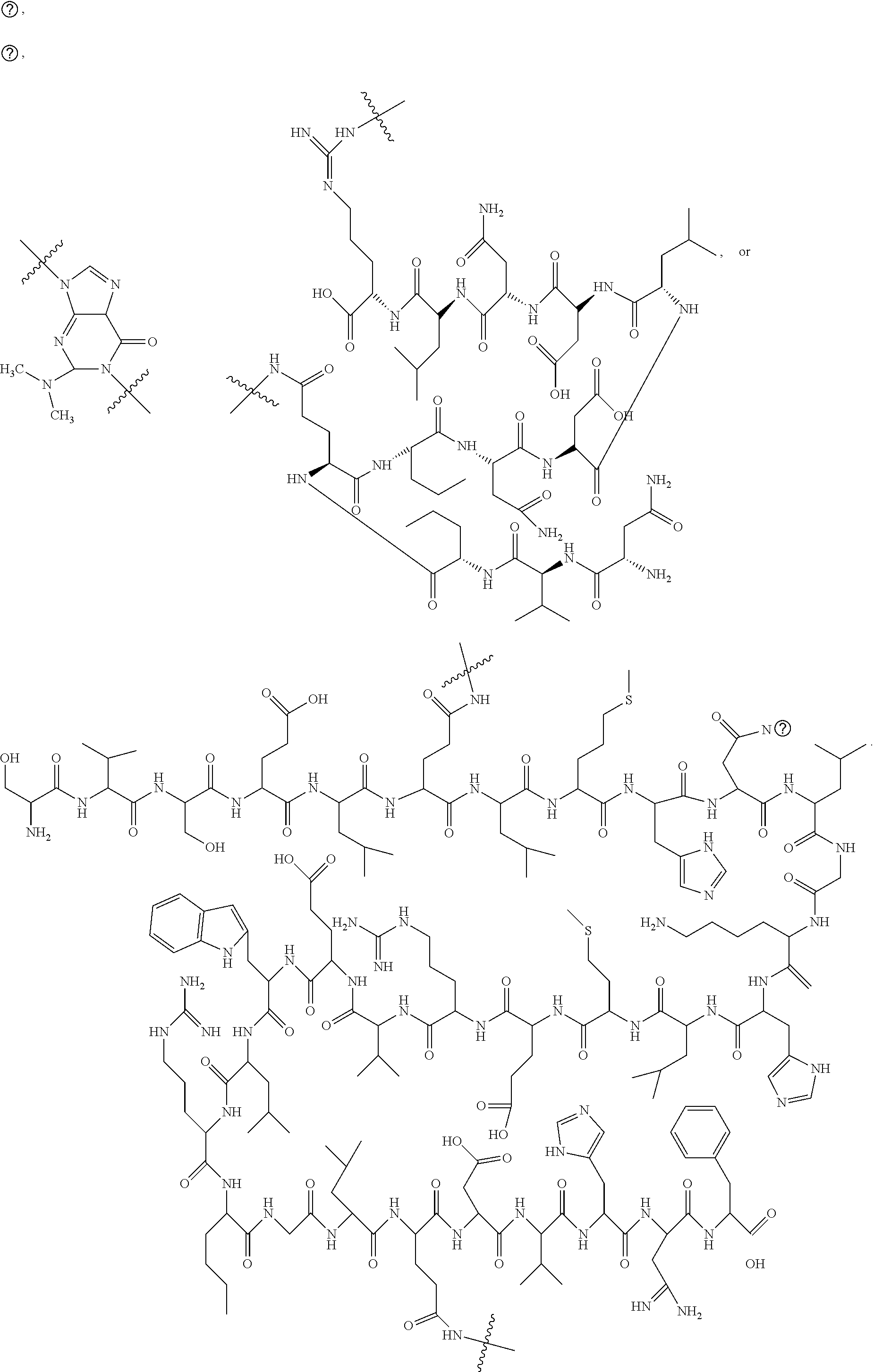

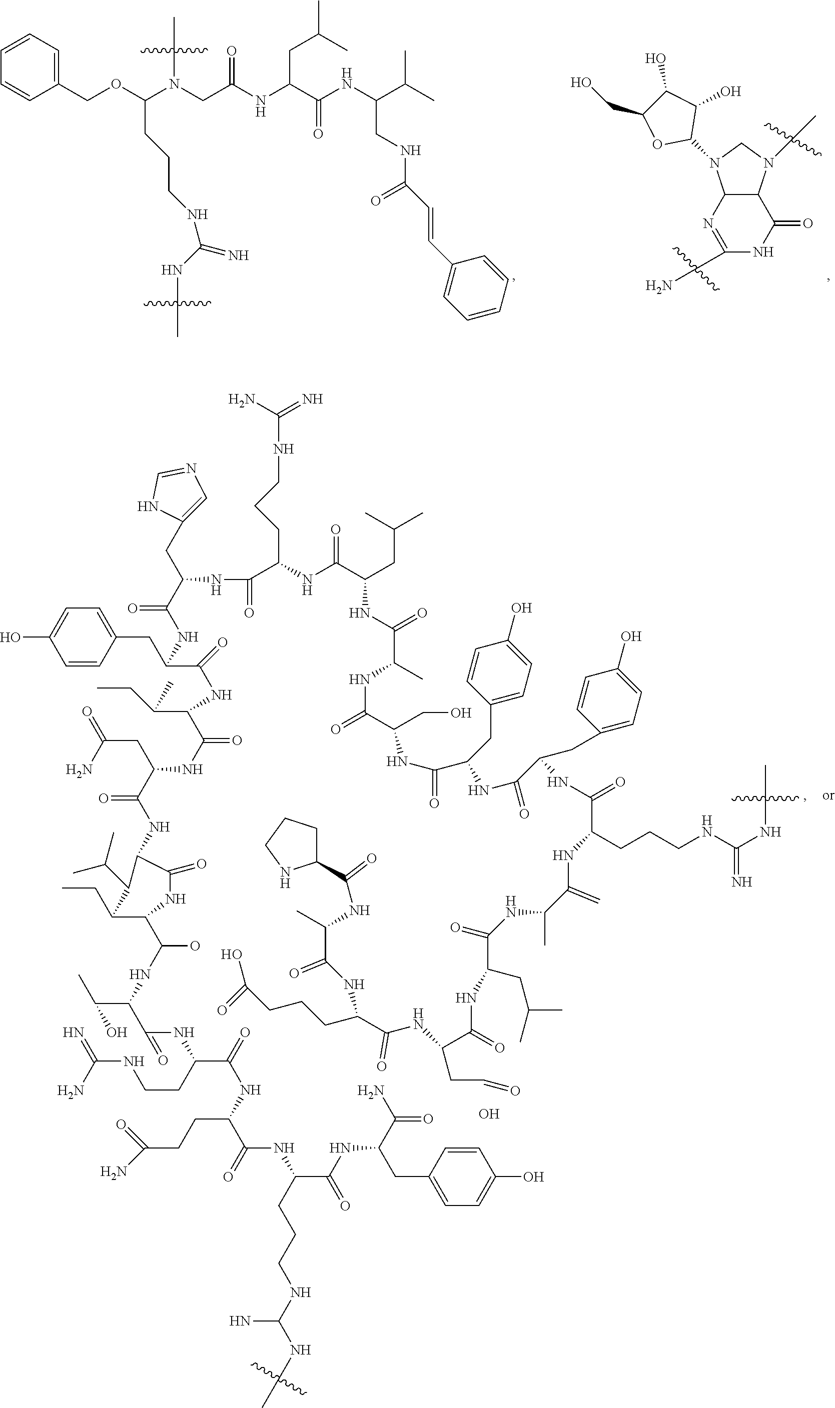

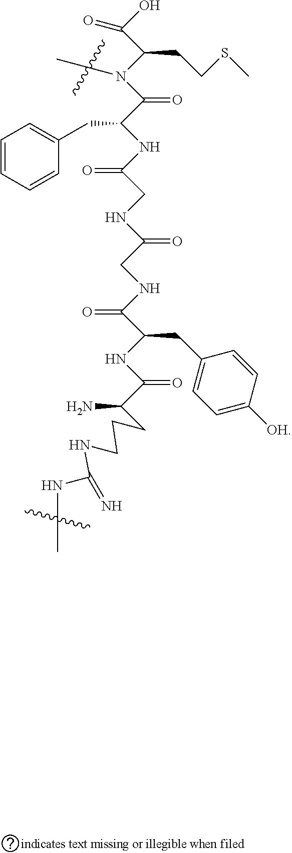 [SMILES: *NC(=N)NCCC[C@@H](N)C(=O)N[C@H](Cc1ccc(O)cc1)C(=O)NCC(=O)NCC(=O)N[C@H](Cc1ccccc1)C(=O)N(*)[C@H](CCSC)C(=O)O]

In another embodiment, the uremic metabolite moiety is urea, uric acid, uracil, xanthine, orotic acid, orotidine, N4-acetylcytidine, N6-threonylcarbamoyladenosine, pseudouridine, xanthosine, cytidine, uridine, or delta-sleep-inducing peptide.

In another embodiment, the urea moiety has the structure

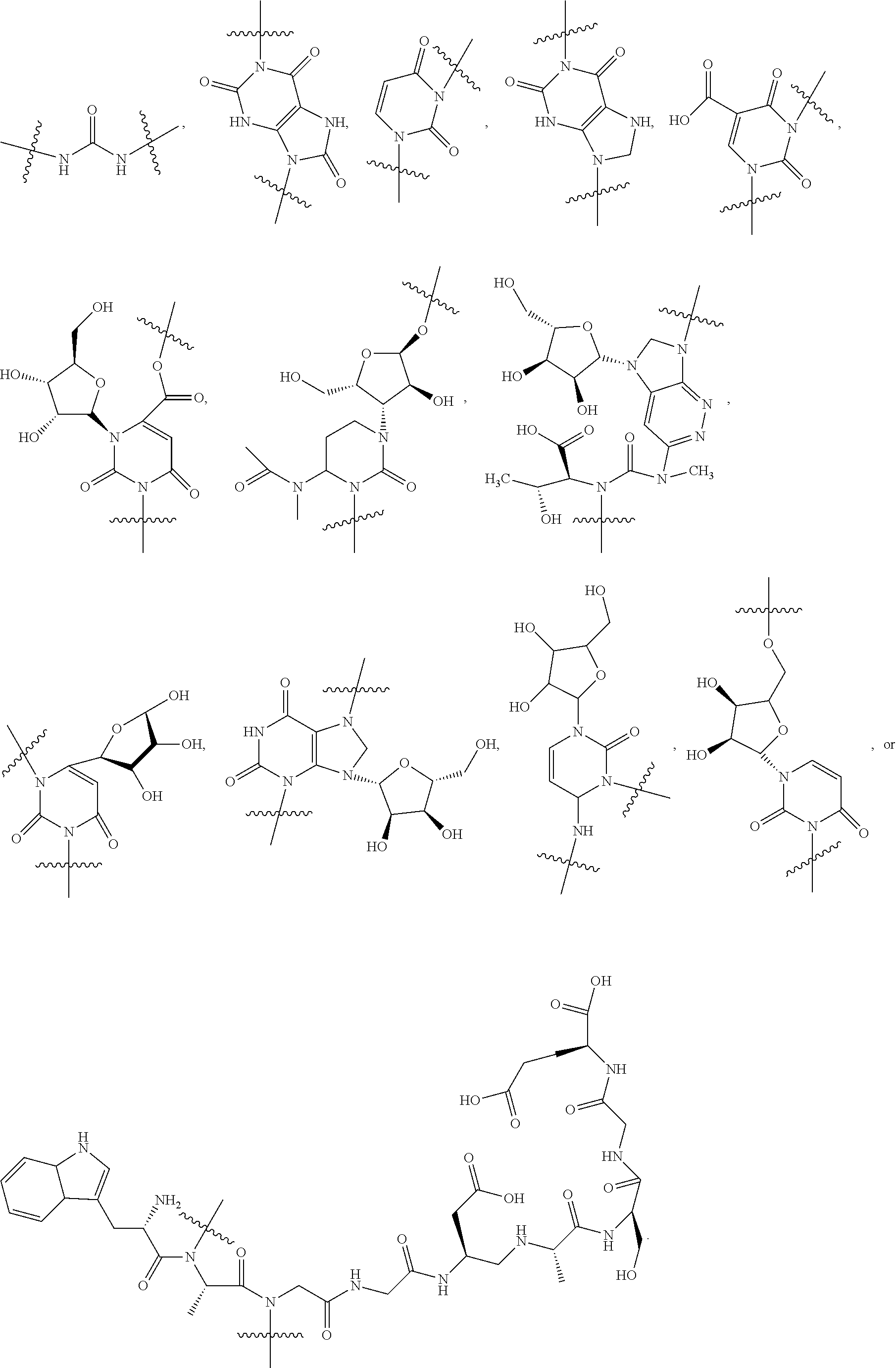

In another embodiment, the phenol moiety is phenol, Methionine-enkepahlin, β Endorphin, myoinositol, hydroquinone, p-cresol, p-cresol sulfate or benzylalcohol.

In another embodiment, the phenol moiety has the structure

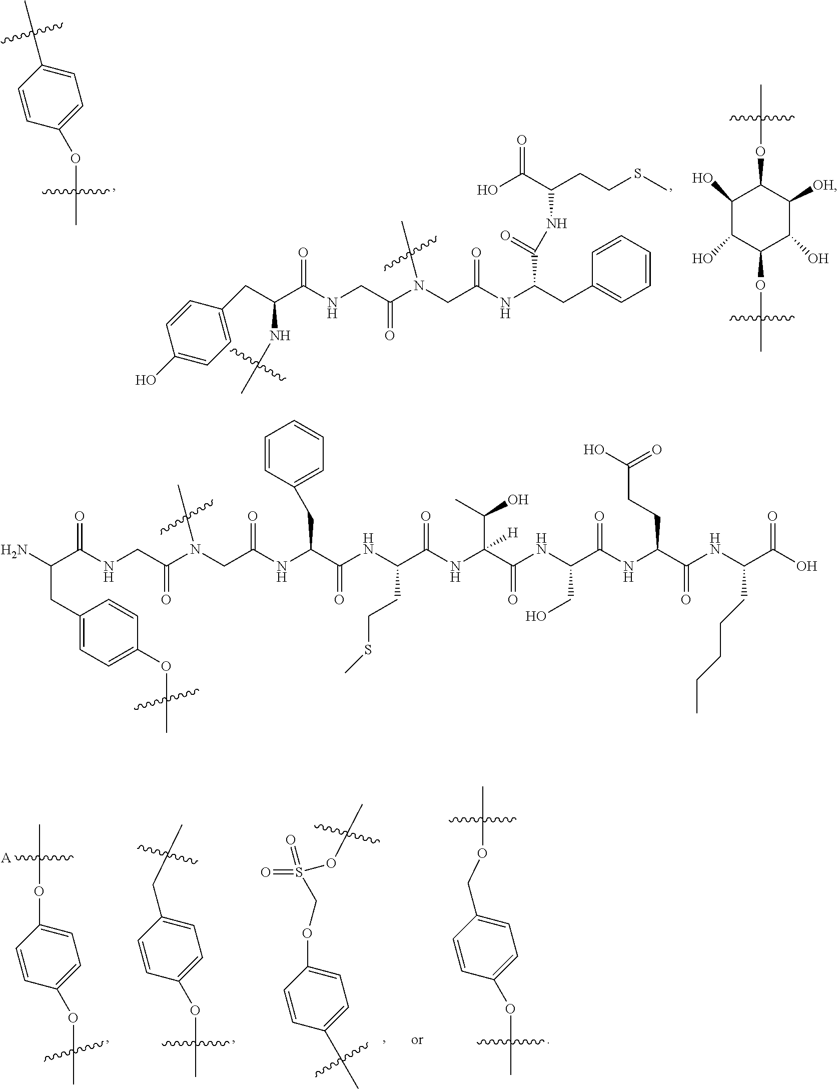

In another embodiment, the indole moiety is indole, indole-3-(carboxy)aldehyde, indole-3-acetic acid, indole-3-propionic acid, indoxyl glucuronide, cholecystokinin, indoxyl sulfate, melatonin, serotonin, tryptophan, endothelin, or tumor necrosis factor alpha.

In another embodiment, the indole moiety has the structure

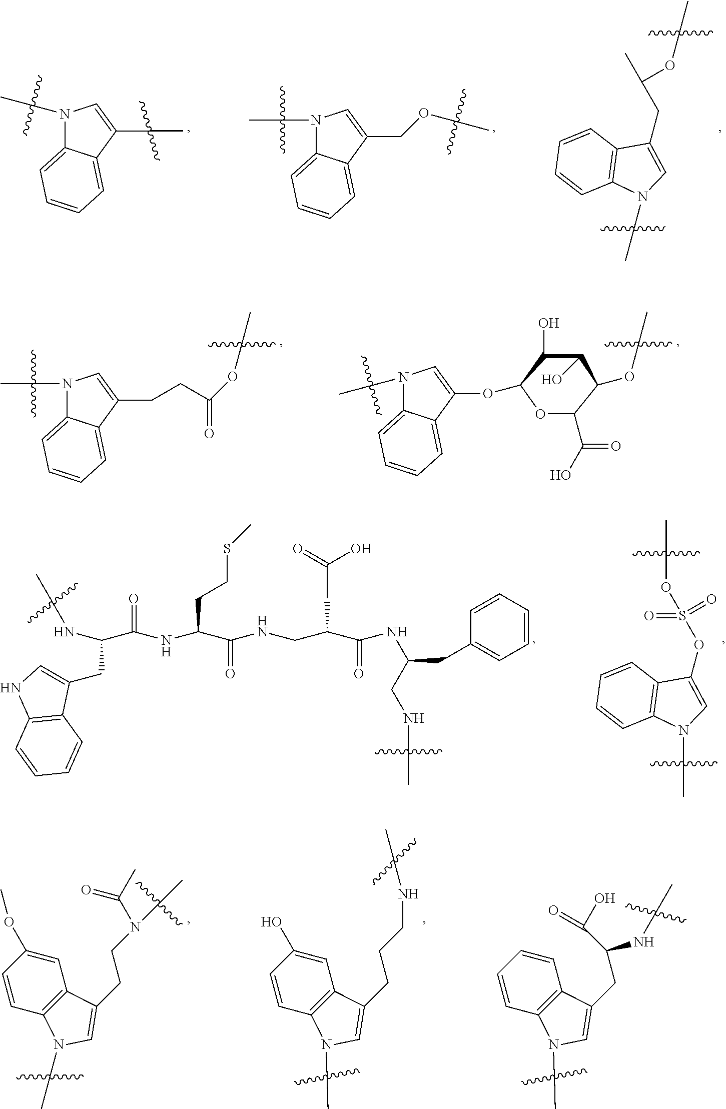

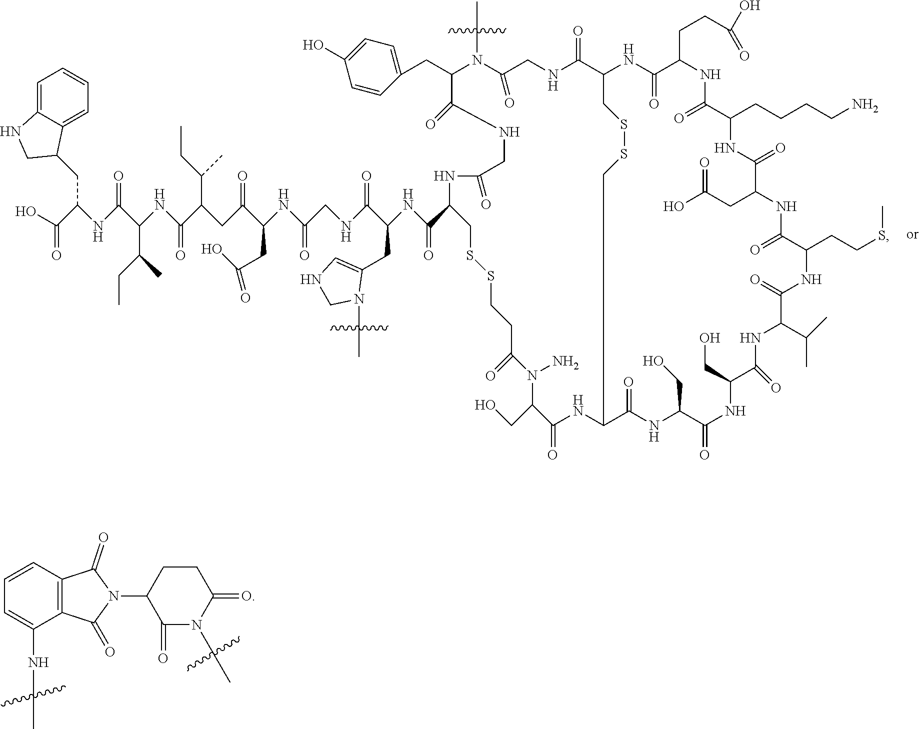 [SMILES: *N1CNC=C1C[C@H](NC(=O)[C@@H]1CSSCCC(=O)N(N)C(CO)C(=O)NC2CSSCC(NC(=O)C(CCC(=O)O)NC(=O)C(CCCCN)NC(=O)C(CC(=O)O)NC(=O)C(CCSC)NC(=O)C(C(C)C)NC(=O)[C@H](CO)NC(=O)[C@H](CO)NC2=O)C(=O)NCC(=O)N(*)C(Cc2ccc(O)cc2)C(=O)NCC(=O)N1)C(=O)NCC(=O)N[C@@H](CC(=O)O)C(=O)CC(C(=O)NC(C(=O)N[C@@H](CC1CNc2ccccc21)C(=O)O)[C@@H](C)CC)[C@@H](C)CC ; "or" ; *Nc1cccc2c1C(=O)N(C1CCC(=O)N(*)C1=O)C2=O]

In another embodiment, the polyamine moiety is spermidine, spermine, cadaverine, putrescine, acrolein, malondialdehyde containing Kappa-Ig light chain, Lambda-Ig light chain, degranulation inhibiting protein I, fructoselysine, N-carboxymethyllysine, homocysteine, 1,3-diaminopropane, agmatine, hypusine, N-glutathionylspermidine, sym-homospermidine, sym-norspermidine(caldine), sym-norspermine(thermine), thermospermine, interleukin 1 β or interleukin 6.

In another embodiment, the polyamine moiety has the structure

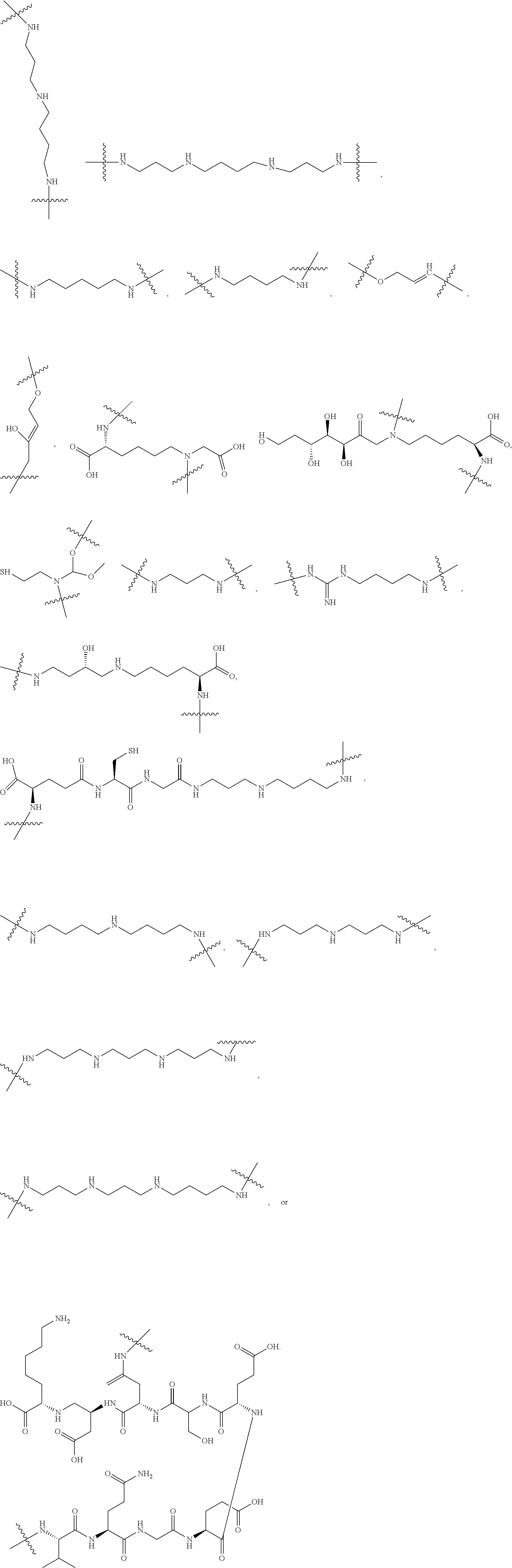

In another embodiment, the glucose moiety Glucose, pentosidine, Glucosepane (containing guanidine), N e-carboxymethyl-lysine, Fructoselysine, 3-deoxyglucosone, glyoxal, Methylglyoxal, 3-carboxy-4-methyl-5-propyl-2-furanpropanoic acid (CMPF), Hyaluronic acid, or Clara cell protein.

In another embodiment, the glucose and advanced glycation end products moiety has the structure

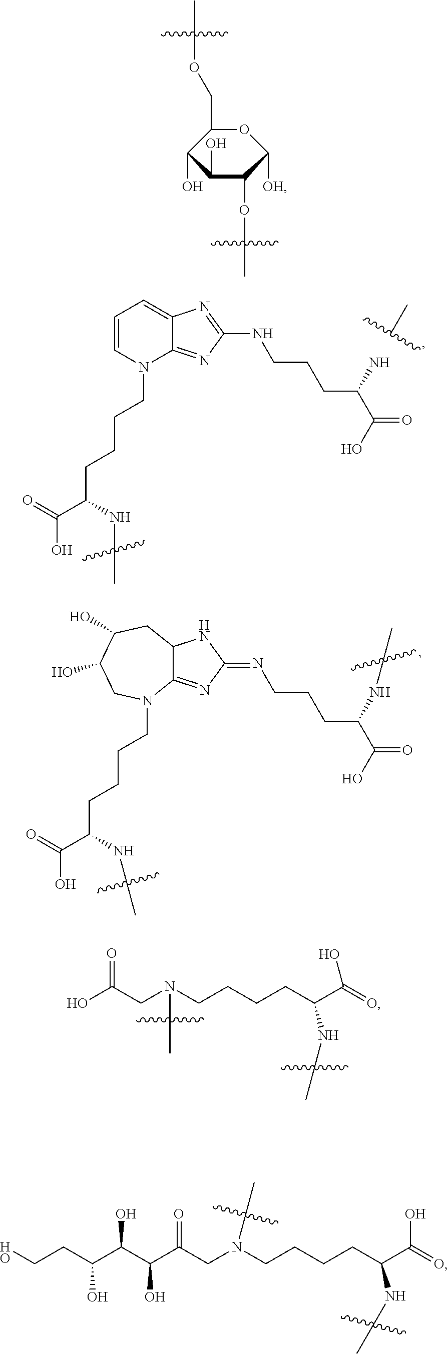

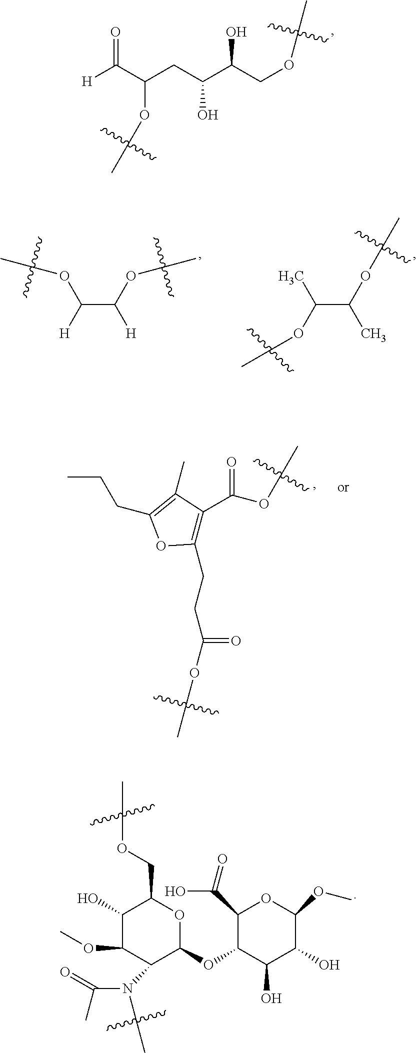

In another embodiment, the hippurate moiety is hippuric acid, p-hydroxy-hippuric acid or kynurenine.

In another embodiment, the hippurate moiety has the structure

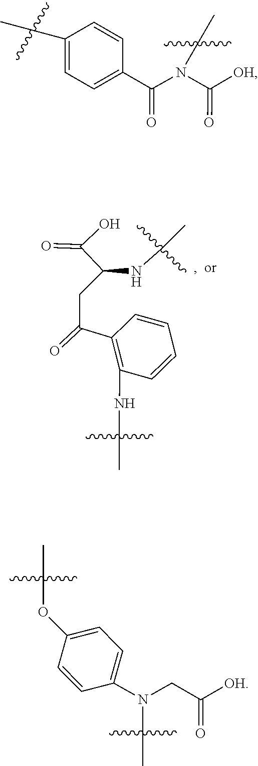 [SMILES: *c1ccc(C(=O)N(*)C(=O)O)cc1 ; *Nc1ccccc1C(=O)C[C@H](N*)C(=O)O ; *Oc1ccc(N(*)CC(=O)O)cc1]

In another embodiment, the polyhydric alcohol moiety is erythritol, arab(in)itol, mannitol, sorbitol, threitol, or myoinositol.

In another embodiment, the polyhydric alcohol moiety has the structure

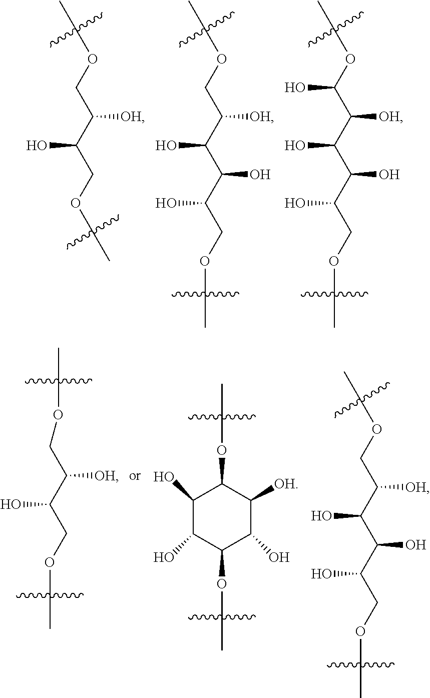 [SMILES: *OC[C@@H](O)[C@@H](O)CO* ; *OC[C@H](O)[C@H](O)[C@@H](O)[C@@H](O)CO* ; *OC[C@H](O)[C@H](O)[C@@H](O)[C@H](O)[C@@H](O)O* ; *OC[C@H](O)[C@@H](O)CO* ; *O[C@@H]1[C@H](O)[C@@H](O)[C@H](O*)[C@@H](O)[C@@H]1O ; *OC[C@H](O)[C@H](O)[C@@H](O)[C@@H](O)CO*]

In another embodiment, the inosine moiety is hypoxanthine, 1-methyladenosine, 1-methylinosine, N6-methyladenosine or complement factor D.

In another embodiment, the inosine moiety has the structure

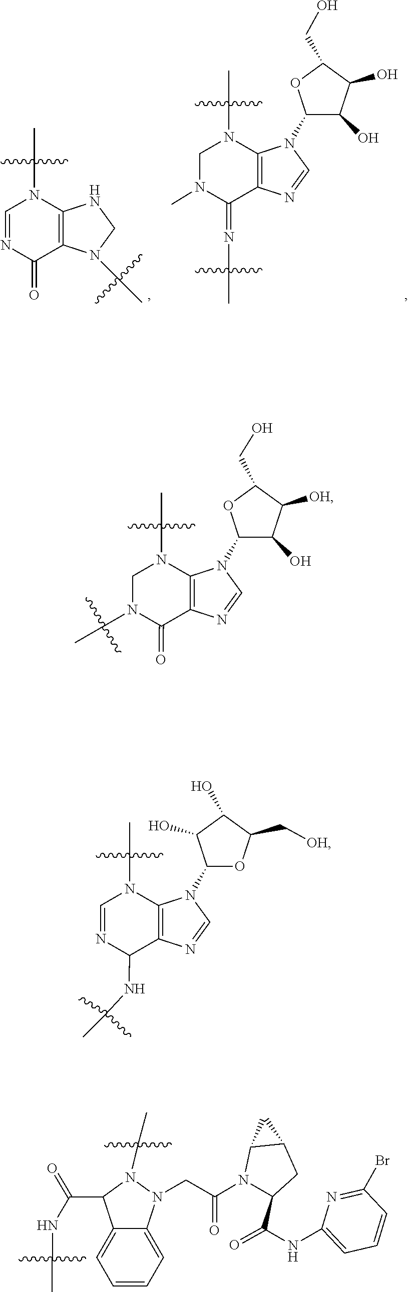 [SMILES: *N1CNc2c1c(=O)ncn2* ; *N=C1c2ncn([C@@H]3O[C@H](CO)[C@@H](O)[C@H]3O)c2N(*)CN1C ; *N1CN(*)c2c(ncn2[C@@H]2O[C@H](CO)[C@@H](O)[C@H]2O)C1=O ; *NC1N=CN(*)c2c1ncn2[C@H]1O[C@H](CO)[C@@H](O)[C@H]1O ; *NC(=O)C1c2ccccc2N(CC(=O)N2[C@@H]3C[C@@H]3C[C@H]2C(=O)Nc2cccc(Br)n2)N1*]

In another embodiment, the oxalate moiety is oxalate, glyoxal, methylglyoxal, or 3-deoxyglucosone.

In another embodiment, the oxalate moiety has the structure

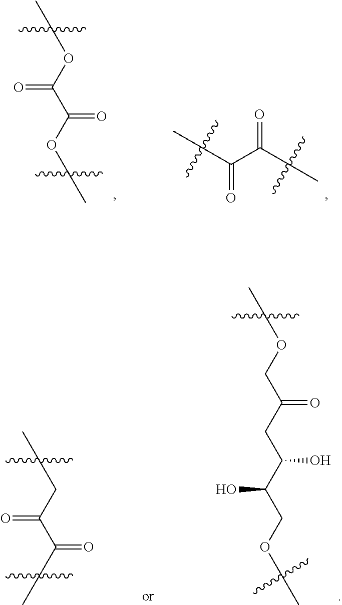 [SMILES: *OC(=O)C(=O)O* ; *C(=O)C(*)=O ; *CC(=O)C(*)=O ; *OCC(=O)C[C@H](O)[C@H](O)CO*]

In another embodiment, the phenyllactic acid moiety is phenyllactic acid, quinolinic acid containing acrolein, kynurenic acid, or retinol binding protein.

In another embodiment, the phenyllactic acid moiety has the structure

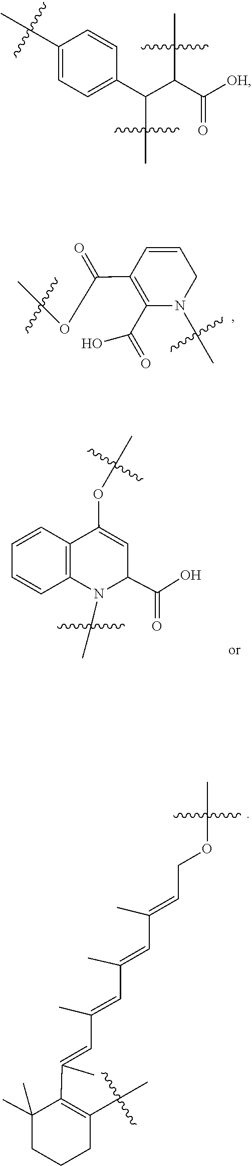 [SMILES: *c1ccc(C(*)C(*)C(=O)O)cc1 ; *OC(=O)C1=C(C(=O)O)N(*)CC=C1 ; *OC1=CC(C(=O)O)N(*)c2ccccc21 ; *OC/C=C(C)/C=C(C)/C=C(C)/C=C(\C)C1=C(*)CCCC1(C)C]

In another embodiment, the zwitterionic moiety is

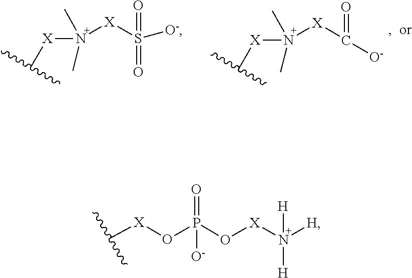

wherein X is independently or simultaneously —(C₁-C₁₀)-alkylene, or —(C₁-C₆)-alkylene or —(C₁-C₃)-alkylene or absent.

In another embodiment, the zwitterionic moiety is

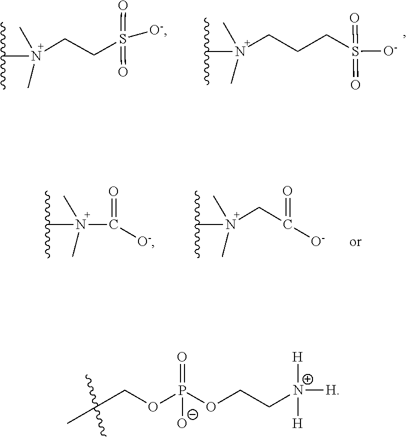

In another embodiment, the positive charge of the zwitterionic moiety, for example a quaternary nitrogen atom, also forms part of the uremic metabolite moiety. For example, spermidine, a uremic metabolite moiety has the following structure:

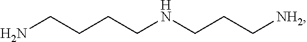

and the UM-ZM moiety is

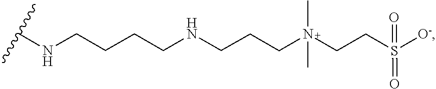

wherein the quaternary nitrogen atom forms part of both the uremic metabolite moiety and the zwitterionic moiety.

In one embodiment, the zwitterionic moiety has a different chain length or different orientation.

In one embodiment, W is absent, NH, —(C₁-C₁₀)-alkylene, or —(C₁-C₁₀)-alkylene-phenyl.

In another embodiment, the membrane materials is:

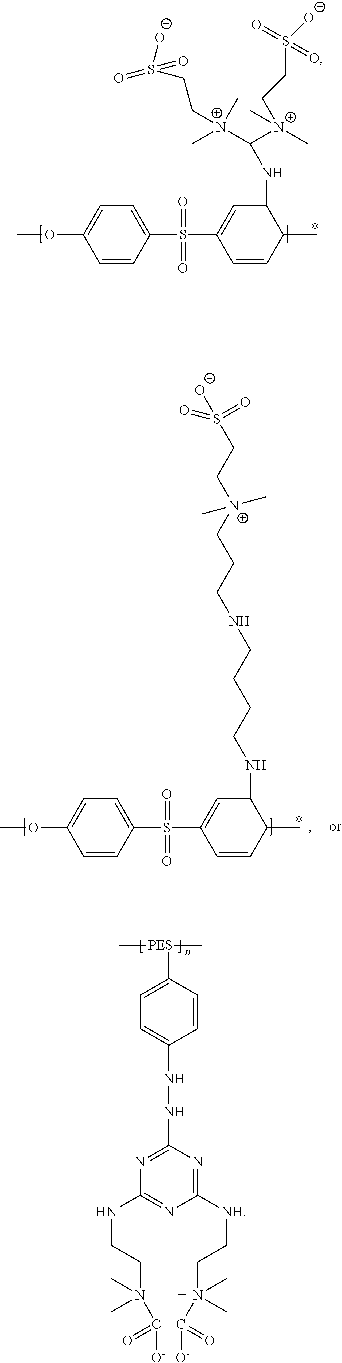

In another embodiment, the uremic metabolite moiety may be directly attached to the polymer. For example, guanidine has the following structure

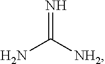

and one of the nitrogens may be directly attached to the polymer, while the other nitrogens form part of the UM-ZW moiety, for example:

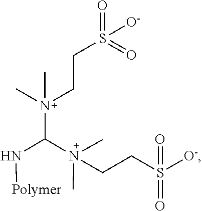

wherein the nitrogen atoms of the guanidine also form the quaternary nitrogen atoms of the zwitterionic moiety. In addition, in this example, the integer m is 1 and p is 2, such that there is one uremic metabolite moiety and two zwitterionic moieties.

In another embodiment, the linker W is any moiety which is compatible with the membrane material and is optional as the uremic metabolite material may be directly bonded to the polymer. In another embodiment, the linker moiety contains functional groups including hydroxyl carboxyl, amine, amine, ether, imine, isocyanate, azo compounds, carboxylic acid, ester, and ketone.

In another embodiment, the present disclosure includes a hemodialysis membrane material having the following structure

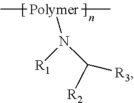

wherein,
n is an integer which represents the degree of polymerization and the number of repeating monomer units of the polymer and is between 1 and 1,000,000;
Polymer is a membrane material polymer;
R₁ is H, or (C₁-C₁₀)-alkyl;
R₂ is a moiety comprising a zwitterionic moiety; and
R₃ is H, (C₁-C₁₀)-alkyl or a moiety comprising a zwitterionic moiety.

In another embodiment, the polymer is

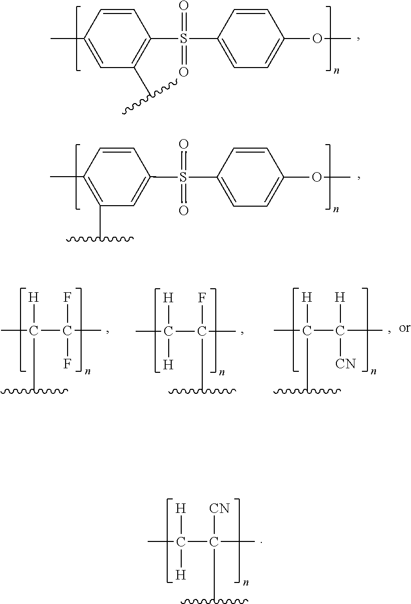

In one embodiment, R₁ is H or (C₁-C₆)-alkyl. In one embodiment, R₁ is H or (C₁-C₃)-alkyl. In one embodiment, R₁ is H.

In another embodiment, R₂ is —(C₀-C₁₀)-alkylene-(Z), wherein one or more of the carbon atoms in the (C₁-C₁₀)-alkylene is optionally replaced with NH, or N(C₁-C₆)-alkyl, and Z is a zwitterionic moiety. In another embodiment, R₂ is —(C₀-C₇)-alkylene-(Z), or R₁ is —(C₀-C₃)-alkylene-(Z). In another embodiment, R₂ is (C₇)-alkylene-(Z), wherein one or more of the carbon atoms in the (C₇)-alkylene is optionally replaced with NH, or N(C₁-C₆)-alkyl, and Z is a zwitterionic moiety. In another embodiment, R₂ is Z.

In another embodiment, R₃ is H, (C₁-C₁₀)-alkyl, or —(C₀-C₁₀)-alkylene-(Z), wherein one or more of the carbon atoms in the (C₀-C₁₀)-alkylene is optionally replaced with NH, or N(C₁-C₆)-alkyl, and Z is a zwitterionic moiety. In another embodiment, R₃ is —(C₀-C₆)-alkylene-(Z), or R₃ is —(C₀-C₃)-alkylene-(Z). In another embodiment, R₃ is Z.

In another embodiment, Z is

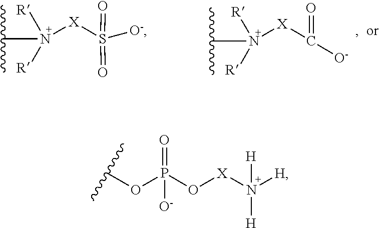

wherein X is independently or simultaneously —(C₀-C₁₀)-alkylene, or —(C₀-C₆)-alkylene or —(C₀-C₃)-alkylene, or methylene, ethylene, propylene or absent; and R′ and R″ are independently or simultaneously —(C₁-C₁₀)-alkyl, or —(C₁-C₆)-alkyl or —(C₁-C₃)-alkyl or methyl.

In another embodiment, the zwitterionic moiety is

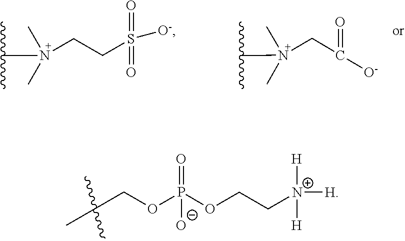

In another embodiment, R₂ and R₃ is

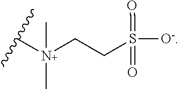

In another embodiment, R₂ is

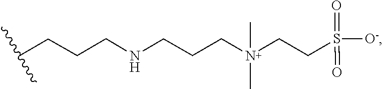

### and R₃ is H.

In another embodiment, the membrane material is

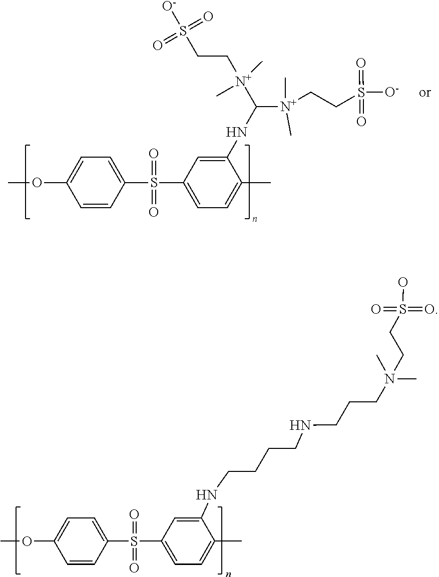

In another embodiment, the membrane material has the following structure

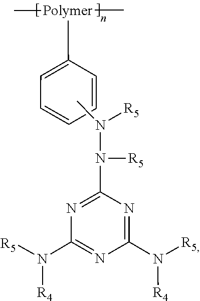

wherein,
n is an integer which represents the degree of polymerization and the number of repeating monomer units of the polymer and is between 1 and 1,000,000; Polymer is a membrane material polymer;
R₄ is a moiety comprising a zwitterionic moiety; and
R₅ is independently or simultaneously H, or (C₁-C₁₀)-alkyl.

In another embodiment, the polymer is

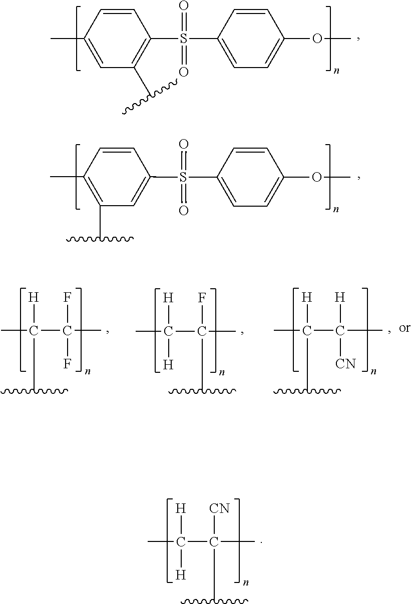

In another embodiment, R₄ is —(C₀-C₁₀)-alkylene-(Z), wherein one or more of the carbon atoms in the (C₁-C₁₀)-alkylene is optionally replaced with NH, or N(C₁-C₆)-alkyl, and Z is a zwitterionic moiety. In another embodiment, R₄ is —(C₁-C₆)-alkylene-(Z), or R₄ is —(C₁-C₃)-alkylene-(Z). In another embodiment, R₄ is (C₂)-alkylene-(Z).

In another embodiment, Z is

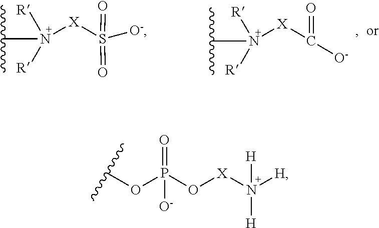

wherein X is independently or simultaneously —(C₀-C₁₀)-alkylene, or —(C₀-C₆)-alkylene or —(C₀-C₃)-alkylene, or methylene, ethylene, propylene or absent, and R′ and R″ are independently or simultaneously —(C₁-C₁₀)-alkyl, or —(C₀-C₆)-alkyl or —(C₀-C₃)-alkyl or methyl. In one embodiment, Z is

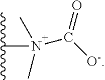

In one embodiment, the membrane material is

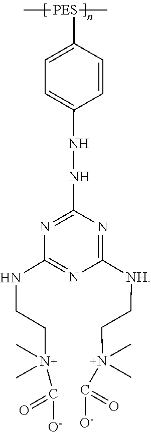

In another embodiment of the disclosure, the membrane material has the structure

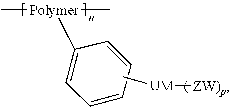

wherein
Polymer is a polymer membrane material;
UM comprises a uremic metabolite moiety;
ZW is a zwitterionic moiety;
n is an integer which represents the degree of polymerization and the number of repeating monomer units of the polymer and is between 1 and 1,000,000; and
p is 1, 2 or 3.

In another embodiment, the zwitterionic moiety is

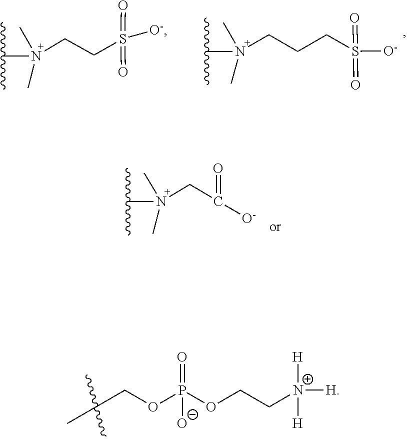

In another embodiment of the disclosure, the membrane material has the following structure

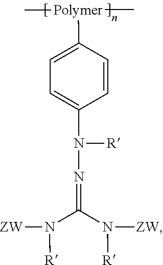

wherein Polymer is a membrane polymer material;
ZW is a zwitterionic moiety;
each R′ is independently or simultaneously H or (C₁-C₆)-alkyl; and
n is an integer which represents the degree of polymerization and the number of repeating monomer units of the polymer and is between 1 and 1,000,000.

In another embodiment of the disclosure, the membrane material has the following structure

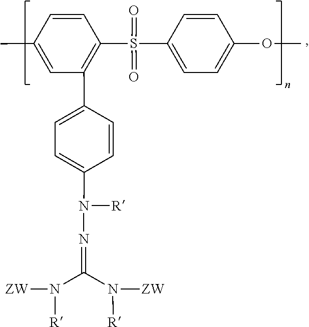

wherein ZW is a zwitterionic moiety;
each R′ is independently or simultaneously H or (C₁-C₆)-alkyl; and
n is an integer which represents the degree of polymerization and the number of repeating monomer units of the polymer and is between 1 and 1,000,000.

In another embodiment, the zwitterionic moiety is

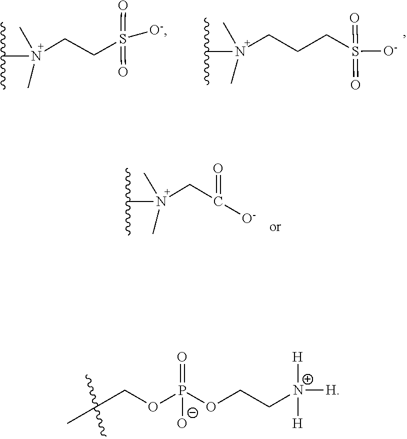

In another embodiment, the membrane material is

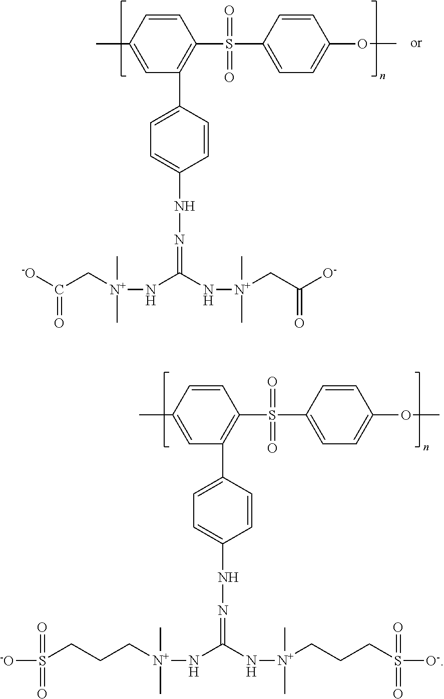

In another embodiment of the disclosure, the membrane material has the following structure

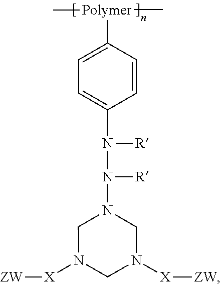

wherein Polymer is a membrane material polymer;
ZW is a zwitterionic moiety;
each R′ is independently or simultaneously H or (C₁-C₆)-alkyl;
each X is independently or simultaneously absent or (C₁-C₆-alkylene), in which one of the carbons in the alkylene group is replaced with nitrogen; and
n is an integer which represents the degree of polymerization and the number of repeating monomer units of the polymer and is between 1 and 1,000,000.

In another embodiment of the disclosure, the membrane material has the following structure

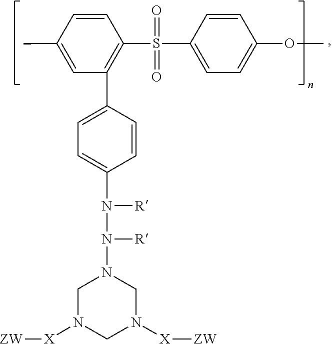

wherein ZW is a zwitterionic moiety;
each R′ is independently or simultaneously H or (C₁-C₆)-alkyl;
each X is independently or simultaneously absent or (C₁-C₆-alkylene), in which one of the carbons in the alkylene group is replaced with nitrogen; and
n is an integer which represents the degree of polymerization and the number of repeating monomer units of the polymer and is between 1 and 1,000,000.

In another embodiment of the disclosure, the membrane material has the following structure

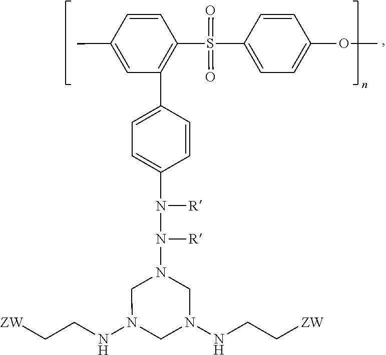

wherein ZW is a zwitterionic moiety;
n is an integer which represents the degree of polymerization and the number of repeating monomer units of the polymer and is between 1 and 1,000,000.

In another embodiment, the zwitterionic moiety is

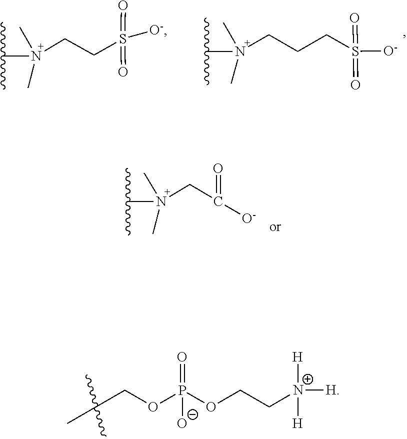

In another embodiment, the membrane material is

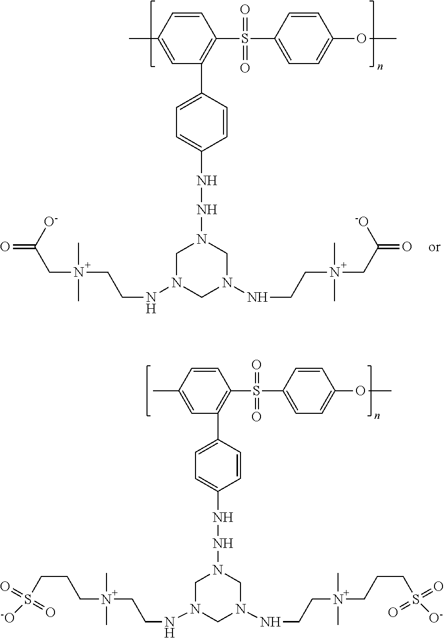

The present disclosure also includes a method for the dialysis or hemofiltration of a patient's blood, wherein the patient is in need of dialysis, comprising contacting the blood with a membrane comprising the hemodialysis membrane material of the disclosure.

Although the disclosure has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present disclosure.

### EXAMPLES

The operation of the disclosure is illustrated by the following representative examples. As is apparent to those skilled in the art, many of the details of the examples may be changed while still practicing the disclosure described herein.

### Materials

Sodium chloroacetate (98%, BCCF2967), Diethylenetriamine (DETA) (99%, ReagentPlus, STBJ5524), dimethyl propane diamine (DMPD, 97%), trichloro triazine (TCT, 99%), guanidine acetate salt (99%, 593-87-3), PVP (molecular weight 360000, 9003-39-8) and 1,3 Propane sultone was (99%, BCBW3681) was purchased from Sigma-Aldrich, St. Louis, Missouri, United States. PES membranes were supplied by Sterlitech (ref code:79772). Methanol (99.9%, HPLC grade, 184031) was received from Fisher Chemicals, Hampton, New Hampshire, United States. Ethanol was purchased from Commercial alcohols (anhydrous, P016EAA), Greenfield global, Toronto, Canada. Deuterium oxide (heavy water, 99.9%) was purchased from Cambridge isotope laboratories, Massachusetts, United States. Liquid nitrogen was provided locally by the Saskatchewan Structural Science center (SSSC) at the University of Saskatchewan, Saskatoon, Canada.

### Example 1—Preparation of Membrane Material

Aminolysis of the PES membrane surface was performed to locate NH₂ sites on the membrane surface. Membrane pieces were immersed in an aminolysis solution (10.0 wt % Diethylenetriamine (DETA) aqueous solution) at 90° C. for 48 h. PES-NH₂ samples were then washed with an extra amount of ethanol to remove excess DETA.

The surface of PES-NH₂ was functionalized with TCT according to the following procedure. TCT was dissolved in n-hexane solvent. PES-NH₂ membrane samples were immersed in the solution while stirring for 16 h. PES-NH₂-TCT samples were washed and stored

N,N-dimethyl-1,3-propanediamine (DMPD, 20 mL in water in ambient temperature) was added to PES-NH₂-TCT membranes under stirring and heating. The mixture was allowed to react for 6-7 h at 89° C. Membranes were washed with deionized water three times until the pH of washing water was 7-8.

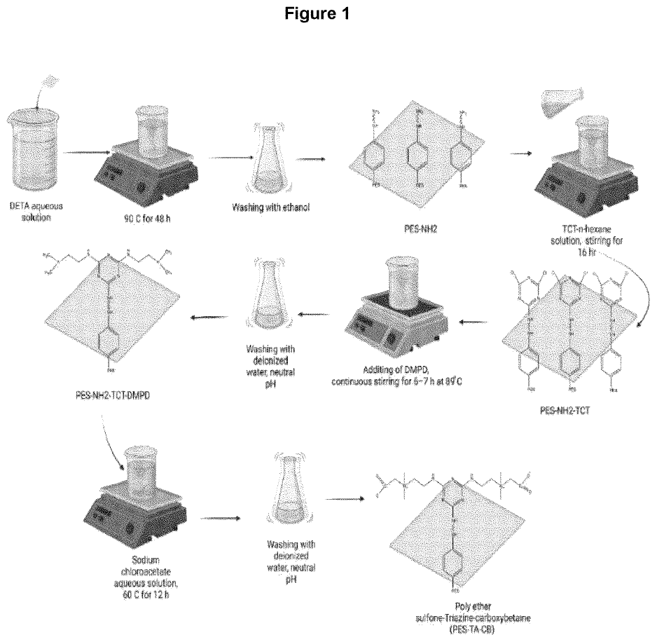

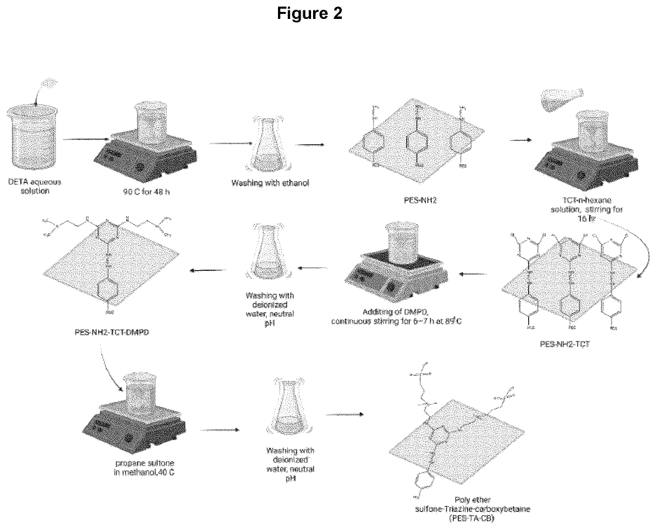

Sodium chloroacetate 4 g in 100 mL deionized water, was added to the PES-NH₂-TCT-DMPD membrane. The reaction mixture was stirred (using a mechanical stirrer) at 60 C for 12 h. The membrane was washed with deionized water until the pH of washing water was 7-8. FIG. 1 shows a schematic illustration of the reactions.

Ring opening of the sulfone structures results in the creation of sulfobetaine (last reaction step).

The advantages of the membrane material is based on the knowledge that water molecules strongly bind to a hydrophilic surface and create a 2-3 nm hydration layer that decreases protein fouling²⁸⁻³⁰

The idea of non-freezable water³¹⁻³⁵ and intermediate water molecules was introduced by Takana et al^{36,37}. Water is believed to take on one of three specific structures when it comes in contact with hydrophilic structures: 1) free water (or bulk water) that freezes at 0° C.; 2) non-freezable water that is tightly attached to the surface of the polymeric structure and does not freeze even at very low temperatures; and 3) intermediate water molecules that are attached to the surface of the membrane or the non-freezable water molecules, and are accordingly less mobile than free water and more mobile than non-freezable water. The membrane design capitalizes on the intermediate water molecules.

Without being bound by theory, the hemocompatibility of the new membrane³⁰ is as follows. When serum blood proteins interact with the membrane, direct contact between the protein and membrane surface is eliminated by the intermediate water layer, the molecules of which are stable enough to stay in place and prevent the protein from touching the membrane surface. Accordingly, proteins do not get triggered or activated. The degree of protection (hemocompatibility) relies on the amount of intermediate water rather than non-freezable water. This is because the non-freezable water is completely fixed by the surface and acts as a rigid structure whereas the intermediate water molecules are only partially attached to the membrane surface through hydrogen bonds, which makes the intermediate water layer flexible enough to directly contact the protein and repel it like a trampoline. The focus here is on the stability of the hydration layer and not just its thickness. Only when appropriate bonded to the surface does the hydration shell act as a protective layer. Based on computational studies, a higher hydrophilicity profile can be demonstrated by a larger number of hydrogen bonds between the water molecules and the modified membrane. The membrane has a more stable hydrophilic layer on the membrane surface and demonstrates better hemocompatibility, i.e., reduced interactions with human serum proteins, reduced blood activation, and reduced inflammation, all of which contribute to improved patient outcomes.

### Example 2—Preparation of Membrane Material

### Membrane Modification

Amine functionalization: Amine functionalization was conducted through aminolysis of the PES membrane surface was performed NH₂ sites on the membrane surface [1,2]. Membrane pieces were immersed in aminolysis solution (50 wt. % aqueous DETA solution) at room temperature for 2 h. PES-NH₂ samples were then washed with an extra amount of ethanol to remove excess DETA. To use GNDM in the direct attachment of the GNDM for amine functionalization, a 50 wt. % aqueous solution of GNDM was used.

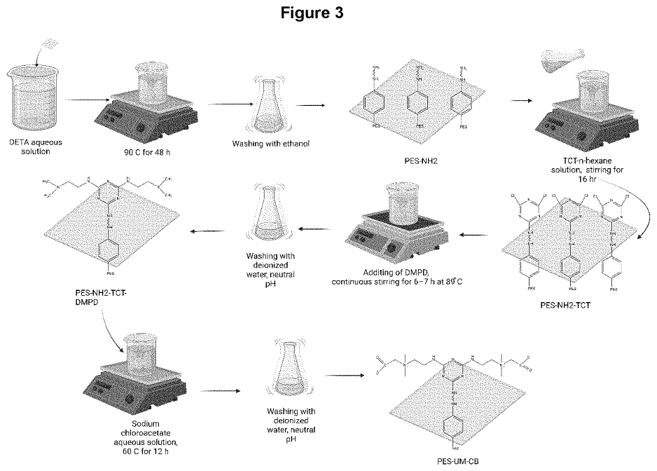

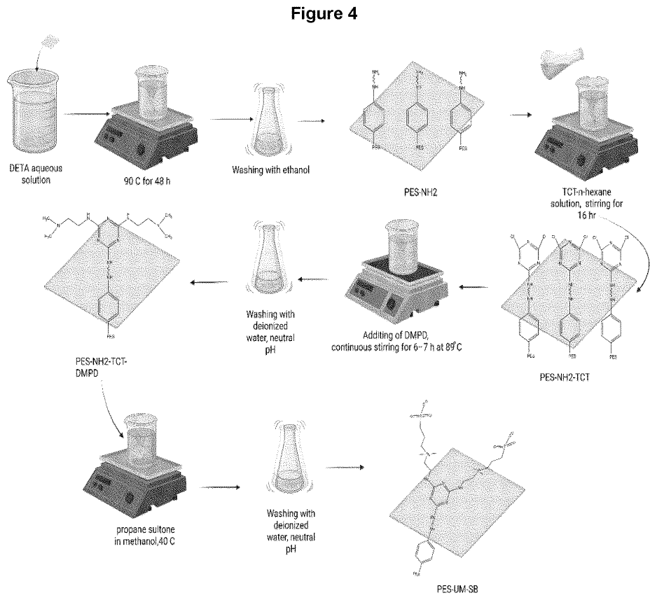

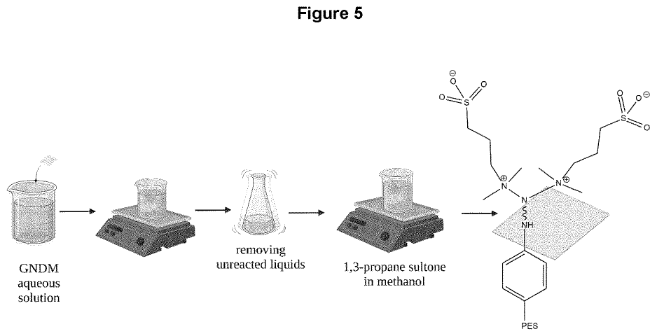

Attachment of the connector chain: PES-NH₂ was functionalized with TCT according to the following procedure [3]. 0.2 g TCT was dissolved in 20 g n-hexane solvent. PES-NH₂ membrane samples were immersed in the solution while stirring for 16 h at room temperature. PES-NH₂-TCT samples were washed and stored. DMPD, 20 mL in water at ambient temperature) was added to PES-NH₂-TCT membranes under stirring and heating [4]. The mixture was allowed to react for 6-7 h at 89° C. Membranes were washed with deionized water three times until the pH of the washing water was 7-8. To connect the carboxyl group to the ammonium moiety, sodium chloroacetate 4 g in 100 mL deionized water, was added to the PES-NH₂-TCT-DMPD membrane. The reaction mixture was stirred (using a mechanical stirrer) at 60° C. for 12 h [4,5]). The membrane was washed with deionized water until the pH of the washing water was 7-8. The membrane was named PES-UM-CB. To create the SB instead of CB as the zwitterionic part of the modification layer, PES-NH₂-TCT-DMPD was immersed in 1,3-propane sultone/methanol solution (0.1 g/ml) for 2 h at 40° C. [6]. The membrane was named PES-GNDM-SB. FIG. 3 and FIG. 4 illustrate the reaction routes to create PES-UM-CB, and PES-GNDM-SB respectively. FIG. 5 reflects the steps for direct attachment of GNDM for SB immobilization on PES membrane.

Simple zwitterionization of the membranes was pursued similar to the fabrication of PES-directGNDM-SB, with the substitution of GNDM with DETA (for the clinical comparison of the membranes).

### Membrane Characterization

### ATR-FTIR

Membrane step-by-step characterization was performed using attenuated total reflectance Fourier transmission infrared spectroscopy (ATR-FTIR, IlluminatlR II FTIR microscope accessory) Smith's Detection, Danbury, United States. Membranes were cut into small (0.5×1 cm) pieces. Samples were vacuum-dried using a JB Platinum (Illinois, United States) vacuum pump equipped with Thermo Scientific (Massachusetts, United States) temperature-controlled air-sealed chamber before the analysis.

### X-Ray Photoelectron Spectroscopy

Surface elemental analysis of the membranes in their initial neat form and functionalized state was conducted using X-ray photoelectron spectroscopy (XPS AXIS Supra, by Kratos Analytical, Manchester, United Kingdom, equipped with a 500 mm Rowland circle monochromated Al Kα (1486.6 eV) X-ray source, the precision of 0.1 to 1 atomic %). Membranes were vacuum dried before scans.

### Surface Roughness

Atomic force microscopy (AFM, nGauge, Integrated Circuit Scanning Probe Instruments, Kitchener, Canada, precision of ±0.5 nm) was used to investigate the surface roughness patterns of the neat and modified PES membranes. The surface roughness characteristics of the samples were obtained from a 25×25 μm area. Parameters are recorded in the form of mean roughness (Sa) and the root mean square (RMS) of the Z data (S_{q}) [7, 8]. Scans were analyzed using the Gwyddion software for the images and parameter extraction [9].

### Surface Charge Measurement

The surface charge of the membrane sheets was measured using a zeta potential analyzer (Zetasizer-Nano Series, Malvern Instruments Ltd., Malvern, United Kingdom, 0.01 mV). To perform this, members were cut to the size of the sample holder (0.5×0.5 cm). Membrane samples were immersed in the standard solution in a cell. The holder with the sample was immersed in 2 mM KCl solution (pH 7). The membrane's surface charge was measured from different membrane-beam angles. The measurements were repeated three times for each measurement by the device for accuracy.

### Pore Size Analysis

Brunauer-Emmett-Teller (BET) and Barret-Joyner-Halenda (BJH) were used for the specific surface area (SA), pore volume, and average pore size measurement of the membrane samples [10]. To conduct the measurements, membrane samples were initially degassed under vacuum conditions. Since the zwitterionic structures could decompose easily at higher temperatures [11], membranes were degassed at 50° C. for 3 hours [12]. Quantachrome Instrument, Graz, Austria (NOVA touch LX², measurement's precision of ±5%) operated with inert nitrogen gas was used for the experiments.

### Analytical Techniques

### Equilibrium Water Content

The Equilibrium water content (EWC) experiment allows the comparison between the membranes regarding their capacity of keeping water in their porous structure. The method was adopted from [13-15]. To measure the amount of EWC, membranes were cut in certain sizes. Samples were immersed in deionized water at 30° C. for 24 h. EWC was calculated as:

$$E W C = ( \frac{{W}_{1} - {W}_{2}}{{W}_{1}} ) \times 100 \qquad ( 1 )$$

where W₁ is the weight of wet membrane and W2 is the weight of the dried sample (dried at 75° C. in an oven for 24 h).

### Gravimetry

To measure the extent of modification grafting yield to the membrane, a gravimetry approach was taken. Neat membranes were dried at 40° C. for 24 h in a vacuum condition and weighted. Zwitterionization was conducted according to the procedure reported previously. The final PES-ZW membranes were also dried at 40° C. for 24 h in a vacuum condition and weighted. The Grafting amount (GA) was calculated according to [16,17]:

$$G A = \frac{{W}_{2} - {W}_{1}}{A} \qquad ( 2 )$$

where A is the surface area of the membrane sample, W1 is the sample's weight before grafting, and W2 is the sample's weight after grafting. The reported results are the average values of 3 measurements.

### Nucleic Magnetic Resonance Spectroscopy

To assess water interaction with the polymeric structures, hydrated samples were scanned using ²H-NMR. Before the scanning, samples were located in sealed NMR tubes and hydrated using deuterium oxide for a week. The ²H-NMR tests were carried out at temperatures ranging from 233 K to 273 K using temperature-controlled NMR equipment (Bruker Avance III HD 600 MHz, Massachusetts, United States). The operating conditions of the device were set to 26.1 MHz with a magnetic field of 7.05 T. Each scan was recorded ten minutes after the temperature was set so that the sample could reach an equilibrium temperature at that temperature.

### Differential Scanning Calorimetry

The methodology to study the hydration state of polymers using the DSC was adopted from [18]. The membrane samples in neat and modified form were cut in a size that could fit in the DSC pan. EWC was measured according to section 3.2.2.1. DSC experiment was performed using the Q2000 TA instruments, Delaware, United States (temperature precision of ±0.1° C.). The hydrated samples were put in an aluminum pan and the pan was sealed with an auto sealer. The pans were cooled to −60° C. at a rate of 5° C./min and held at −60° C. for 5 min. The samples were then heated for the ice-to-water cycle at the same rate to 40° C. The DSC heating profile of PES was used as the control. The DSC device was used to measure the amount of free water. Based on the equations introduced in [19, 20], the amount of stable water (non-freezable water) on the surface is calculated as follows:

$$E W C = {ω}_{f r e e z a b l e} + {ω}_{n o n - f r e e z a b l e} = \frac{Δ {H}_{f r e e z a b l e}}{Δ {H}_{B u l k}} \times 100 + {ω}_{non - freezable} \qquad ( 3 )$$

where ΔH_{Bulk} is equal to 355 J/g and ΔH_{freezable} can be obtained from the thermograms of the DSC.

### Clinical Ex-Vivo Study

Ex vivo assessment was pursued to measure the extent of platelet factor 4 (PF4) secretion as an indicator of platelet activation [21]. To do so, uremic blood from hemodialysis patients in Saint Paul Hospital (Saskatoon, Saskatchewan, Canada) was collected according to the ethics protocols. The study included two groups: uremic patients (n=3) and normal controls (n=3). The patients had a BMI ≥27 kg/m2 and no co-existing medical conditions such as diabetes, hypertension, or peripheral vascular disease. Platelet factor levels were measured using the Human CXCL4/PF4 Quantikine ELISA Kit. In this experiment, 50 μL of the standards or samples are added to duplicate wells in a 96-well plate. 100 μL of Assay Diluent RD1-15 is then added to each well, and the plate is covered with an adhesive strip and incubated for 2 hours on a microplate shaker. The wells are then aspirated and washed with a wash buffer four times. 200 μL of Human PF4 Conjugate is added to each well, and the plate is incubated again for 2 hours on a shaker. The wells are washed again, and 200 μL of the substrate solution is added to each well and incubated for 30 minutes. The reaction is stopped by adding 50 μL of stop solution to each well, and the plate is mixed well before being read with a BioTek SynergyHT microplate reader. Detailed information regarding the materials, reagent preparation, sample preparation, and assay procedure can be found in the supplementary materials. The measurements were repeated three times, and standard deviations were calculated based on our recent publications [22, 23].

### Results and Discussions

### Indirect Attachment of GNDM for Zwitterionization

### FTIR Characterization of Neat and Functionalized PES Membranes

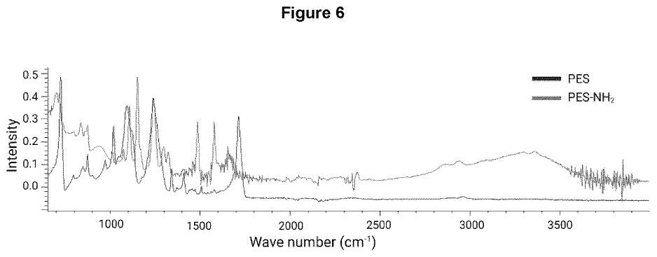

To assure that the chemical structures were successfully located on the membranes, ATR-FTIR characterizations were performed on PES neat and functionalized PES membranes, after each step of functionalization. FIG. 6 depicts the spectra for the PES membrane sample as well as amine-functionalized PES through aminolysis (at 20° C., for 2 h with the DETA concentration of 50 wt. %). The characteristic peaks for the PES membrane are the weak asymmetric stretching vibration peak around 1340 and the symmetric vibration peak at 1134 cm⁻¹ [24]. The sulfone characteristic peak could also locate in a different location (stretching vibrations 1242 cm⁻¹ and 1124 cm⁻¹ for the PES membrane [25]).

Aminolysis resulted in the formation of a weak peak around 1294 cm⁻¹ which represents the stretching vibration band of C—N confirming that nitrogen is attached to the carbon backbone of the PES [24]. Common IR amine peaks are reported to be between the wavenumber of 3000 to 3500 cm⁻¹ [26]. This broad peak is attributed to the hydrogen bonding formed between hydrogen Previous reports of aminolysis performed on PES also suggest the same range for the desired amine [27]. The broad peak at around 3200 cm⁻¹ is related t the strong hydrogen bonding of water molecules while the broad peak around 3500 cm⁻¹ is of the less strong hydrogen bonds. In other words, stronger hydrogen bonds tend to have lower wave numbers [28, 29]. According to Zhao et al, the amine peak at this range is a broad peak centered around 3400 cm⁻¹ [30] similar to what we have achieved. Another peak around 1540 cm⁻¹ also represents NH functional group [31, 32]. Accordingly, the wide peak in this region reflects the successful amine functionalization of PES. DETA-assisted amine functionalization of other membranes has been reported to result in a peak around 660-670 cm⁻¹ [33].

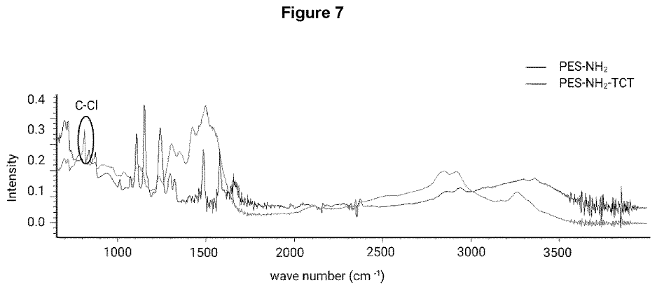

Functionalization of PES-NH₂ with TCT must reduce the amount of NH₂ peak and lead to the appearance of new peaks related to the triazine chloride ring. These peaks could be listed as the stretching vibration modes of the C—N heterocycle peak in the region 1300-1700 (similar strong absorption bands at 1631, 1450, and 1392 were reported in other literature [34]). The stretching absorption of unreacted C—Cl would also appear between 700 to 865 cm⁻¹ [34, 35]. Based on FIG. 7 peak at 839 reflects the C—Cl bond in our PES-NH₂-TCT membrane.

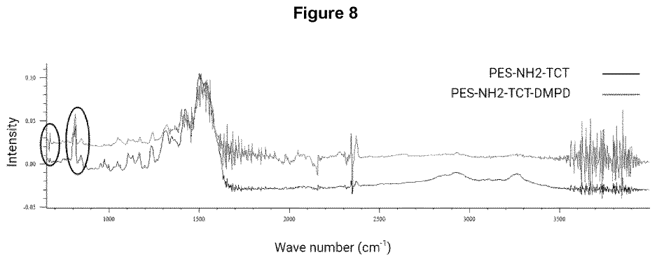

FIG. 8 reflects the comparison between the PES-NH₂-TCT membrane samples and the PES-NH2-TCT-DMPD sample. The attachment of DMPD to the membrane should dilute the C—Cl characterization peak and increase the N—C peak between the carbon in the ring and the nitrogen from DMPD. The addition of DMPD should ideally cancel the peak for C—Cl around 800 cm⁻¹. The increased C—N peak between the carbon and nitrogen in the DMPD was also observed at 2300 cm⁻¹. The addition of carboxy betaine final block to the functionalized membrane results in the formation of an acid carbonyl (—COOH) peak at 1726 cm⁻¹ [25]. Since the immobilization of triazine chloride was more intense than the attachment of DMPD, an excess amount of chlorine exists on the membrane surface as the peaks still exist in the same region, however, the intensity of the peaks was decreased. The appearance of amine functional groups due to the presence of the unreacted side of the DMPD is approved by the sharp peak around 660-670 cm⁻¹.

### X-Ray Photoelectron Microscopy

Surface characterization of the neat and modified membranes was performed through XPS as a common superficial membrane assessment. Table 1 reflects the elemental analysis of different membrane samples as well as the final zwitterionized membrane.

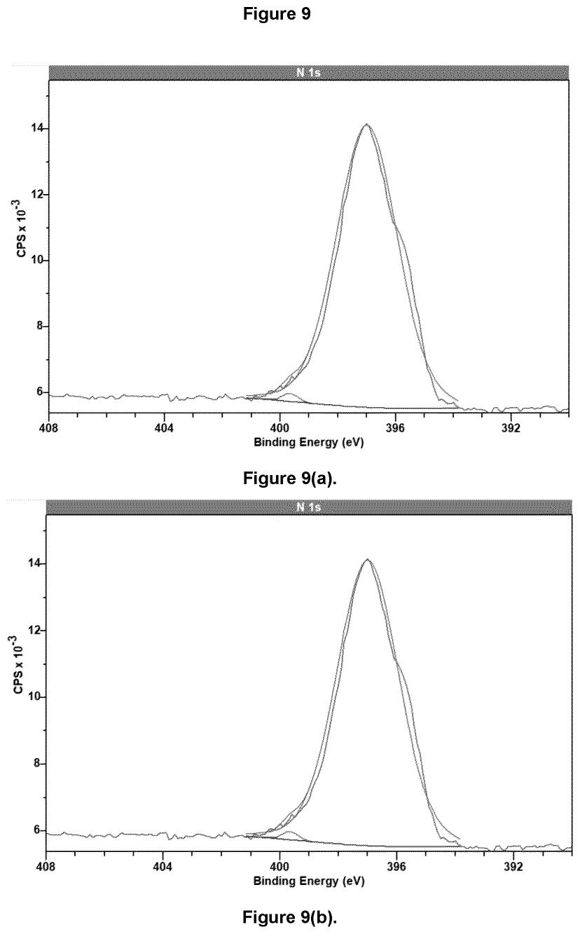

FIG. 9 reflects the XPS spectra of the final PES-UM-CB modified membrane. FIG. 9(a) reflects the nitrogen scan for the sample. The more intense peak around 397 eV reflects the neutral nitrogen while the smaller peak at 400 eV reflects the positively charged nitrogen. The lower content of ammonium in comparison with neutral nitrogen could be due to the aminolysis reaction nature, as it is less intense in comparison with acid-washing techniques. FIG. 9(b) reflects the carbon peaks of the modified membrane. The peaks near 284.8 and 285.4 eV are attributed to C—H (as well as C—C) and C═O structures. The broad peak at 289.5 could be attributed to the O═C—O of CB moiety of the zwitterionic structure [36]. The oxygen peaks of the modified membrane are also depicted in FIG. 9(c). The appearance of oxygen peaks proves the CB negative moiety. Zwitterionization of the PES membrane resulted in broadened oxygen peak which could be split in binding energies and could be divided into two extra split peaks rather than the C—O—H peak. The two peaks, 528.5 eV for the C—O bond and 531.5 eV for C═O represent [O—C═O], and [O—C═O⁻] structures in the CB [37].

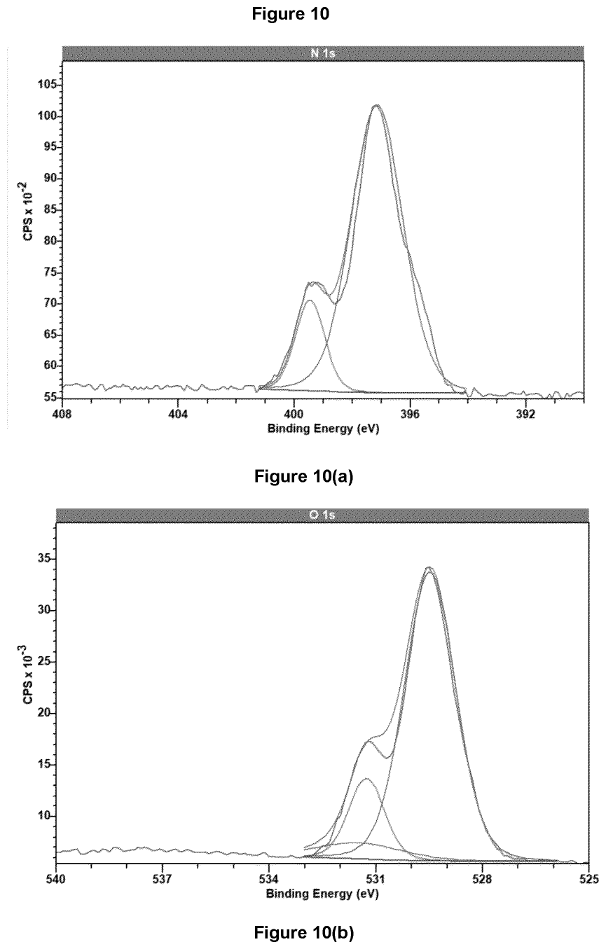

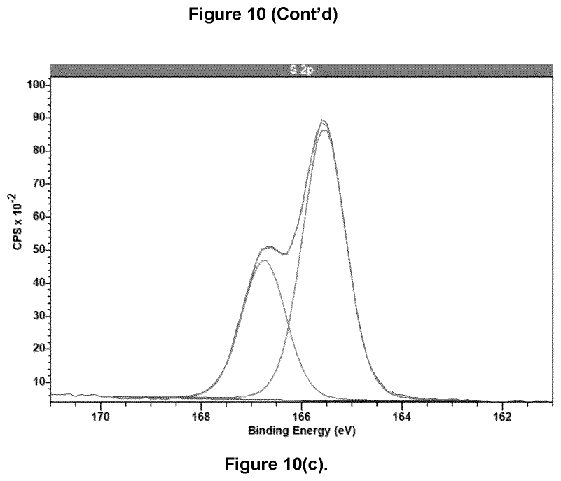

The nitrogen, oxygen, and sulfur peaks of the PES-UM-SB membrane are illustrated in FIGS. 10(a), 10(b), and 10(c). As could be seen in FIG. 10(a), the charged nitrogen pean is more intense in comparison with the PES-UM-CB membrane. This could be due to the difference between the nature of the reactions used for zwitterionization. Accordingly, a ring-opening reaction could lead to higher content of positively charged nitrogen on the membrane surface. The deformed S 2p peak for the PES-UM-SB membrane is due to the addition of SO₃⁻ moiety of the ZW structure which could be divided into three peaks similar to previously reported characteristics of SB [38]. O 1s analysis of PES-UM-SB also shows the peak of SO₃⁻ at 532 eV (FIG. 10(c)) [39].

The sulfur content of the PES membrane (5.90%) was halved for the final modified PES-UM-CB membrane and increased for the PES-UM-SB membrane due to the existence of SO₃⁻. The higher content of chlorine in the PES-UM-CB sample reflects that sodium chloroacetate did not react well with the nitrogen end of DMPD and the residual amount of Cl from chloroacetate remained in the membrane porous structure. On the other hand, the Cl content for the PES-UM-CB was zero, showing that the chlorine content in the PES-UM-CB is not related to the TCT structure.

### Grafting Amount

To measure the amount of modification layer added to the membranes after zwitterionization, gravimetry was used. Table 2 reflects the modification layers' GA and the related error values. The GAs obtained here for the modified membranes, are more than the common values reported for the zwitterionization approaches [40, 41]. Common zwitterionization approaches result in a GA value between 0.1 to 0.5 mg [42]. The 100-fold increase in our samples reflects the formation of a completely new layer on the membrane (as assessed through the SEM images). The middle step of the modification (addition of TCT to attach a heterocyclic carbon-nitrogen ring to the amine-functionalized PES membrane) results in the formation of a second layer on the top of the surface, based on the visual observations. Accordingly, the GA values reflect both the secondary layer weight and the zwitterionic structures added to the membranes.

### Surface Roughness

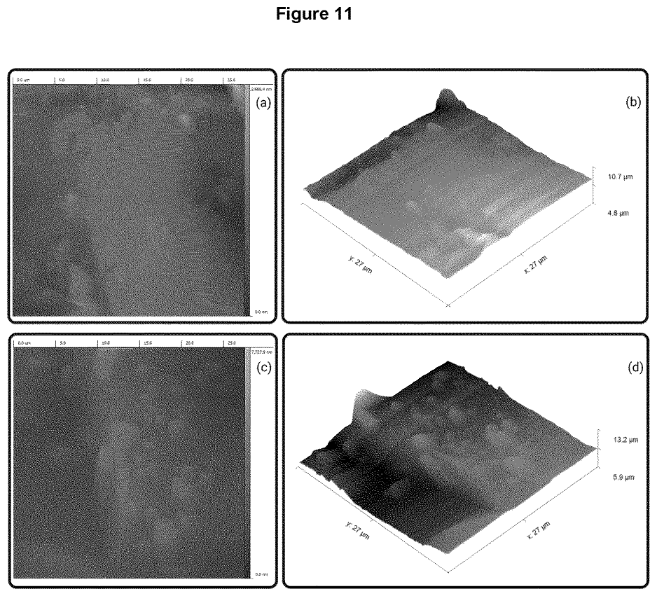

To be able to compare the roughness parameters to our previous PES membrane samples, 10×10 μm areas of the scans were selected. Table 3 compares the roughness parameters of the currently modified membranes with the neat membrane scanned in our previous paper. FIG. 11 illustrated the top and 3-dimension (3D) view of the scans. Both modification approaches resulted in rougher surfaces. For the UM-SB, the roughness increased nearly 10 folds in comparison with neat PES (from 52.61 to 518.8 nm for Sa, and from 68.16 to 589.4 nm for Sq). UM-CB modification resulted in lower roughness parameters in comparison with UM-SB, however, the parameters are still higher than neat PES (371.3 nm for Sa, and 456.2 nm for Sq). The higher roughness parameters could be explained by the modification approach steps. Since the coating technique was used for top surface modification, residual TCT constituents could stay on the top of the membrane surface, either as bonded structures to the membrane top surface or as partially trapped clusters on the porous structure of the membrane. The 3D scans show the clusters on the top of the membranes. The difference between the UM-SB and UM-CB is due to the different nature of the final modification layer (negative end moiety of the ZW structures) and the different sources of chemicals. The UM-SB was made using a ring opening of a cyclic structure, a sultone. The UM-CB was created using a linear structure, sodium chloroacetate. Our previous investigations on simple zwitterionization of PES membranes through aminolysis reflect the same pattern of difference. In our previous research paper, we found that ziwtterionization of aminated PES through the ring opening of sultone creates a rougher surface in comparison with zwitterionization of the same membrane with chloroacetate.

### Surface Pattern Assessment

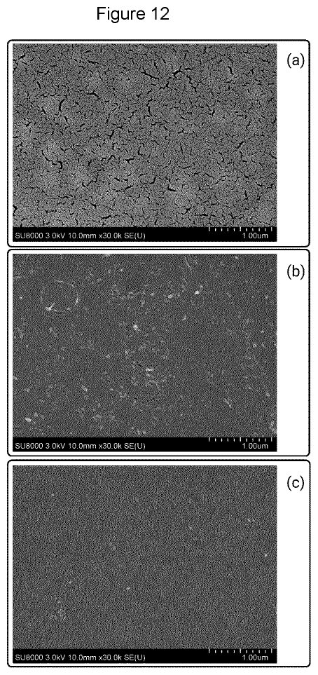

SEM images were collected to check the pore size and surface patterns of the neat membrane. More importantly, the variations in the pore size as a result of the addiction of the modification layer were studied. FIG. 12 shows the SEM micrographs of the neat and modified membranes. the surface pattern of the neat PES UF membrane was similar to previous samples reported elsewhere, with pore sizes between 50 to 100 nm [43]. After the implementation of the modifications, both membranes showed smaller pore sizes (less than 20 nm) and different surface patterns. Then change in the top surface pattern could be due to the middle modification step (using TCT to form the cyclic structure which could be turned into guanidine after the addition of DMPD). The membrane PES-UM-CB reflected smaller pores in comparison with PES-UM-SB. The difference between the two modified membranes could be due to the different nature of sodium chloroacetate and propane sultone which were used for adding the final negative moiety for PES-UM-CB and PES-UM-SB respectively.

### Surface Charge Measurement

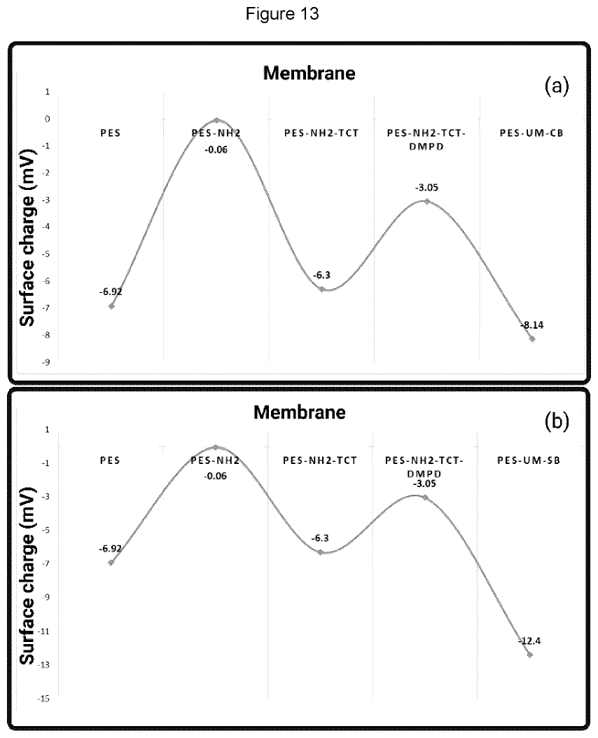

Zeta potential reflects the superficial electric charge on the membrane. Different modifications result in a different positive or negative charge on the membrane surface and within its pores. FIG. 13 reflects the measured surface charge of neat and modified membranes. According to the reported numbers in FIG. 13, PES owns a negative charge equal to −6.9 mV, due to its sulfone functional groups. Aminolysis, resulted in the addition of a positive charge so that the surface charge reached −0.06 mV. The addition of TCT which is a neutral structure, created a layer on the membrane surface, leading to an overall negatively charged surface. This means TCT reacted with the nitrogen available on the membrane surface, resulting in the negative charge of the sulfone structures being dominant again. The addition of DMPD resulted in an increase in the surface charge to the value of −3.05 mV. The final membranes own a more negative charge in comparison with the DMPD-coated membrane with the values of −8.14 mV for the PES-UM-CB and −12.4 mV for the PES-UM-SB.

### Equilibrium Water Content (EWC)

Table 4 reflects the EWC content of the modified membranes. PES is a hydrophilic structure as previously discussed in phase 4, and accordingly, it could own an EWC content as high as 43%. The addition of UM-CB to the PES structure resulted in a 5% increase in the EWC. UM-SB resulted in nearly 10% in comparison with PES. Accordingly, PES-UM-SB has a higher chance to absorb water to create a stable hydration layer within its structure.

### Porosity Assessment

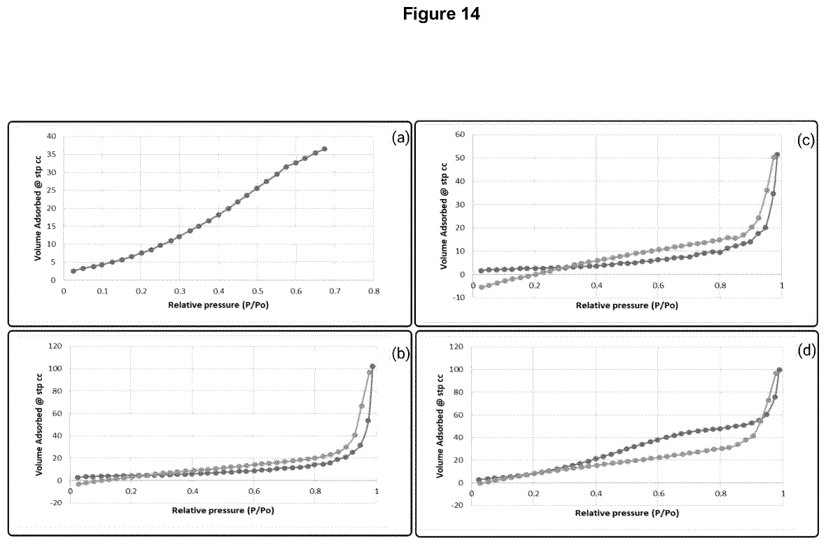

SA, pore volume, and average pore size of the neat and modified membranes are reported in Table 5. The reported data here is in the range of previous research conducted on flat sheet membranes [44]. The untreated membrane sample has a SA equal to 78 m²/g. layer-by-layer coating of the modification layers resulted in a steep and moderate decrease of SA for PES-UM-CB and PESOUM-SB (9 and 63 m²/g) respectively. The nitrogen adsorption isotherms for the neat and modified membranes were assessed which are illustrated in FIG. 14. The neat membrane (FIG. 14 (a)) showed no hysteresis which means the membrane is a microporous structure with pores bigger than 50 nm (also approved through neat SEM image (FIG. 12 (a)). The middle product (PES-TCT-DMPD) was checked to better understand the effect of middle chemical modification steps on the microstructure of the membrane. FIG. 14 (b) reflects the hysteresis for PES-TCT-DMPD. The adsorption and desorption of the isotherms are not aligned. This reflects a microstructure with a pore range of 2 to 50 nm since nitrogen could not leave the pores at the same rate as it was adsorbed [45,46]. Similar patterns were observed in FIGS. 14 (c) and (d). Accordingly, the microporous structure of the membrane which was previously observed in the SEM images (FIG. 12), is associated with the application of the middle chemical modification steps to locate the UM mimicking structure of guanidine on the membrane

### 3.1.9. Non-Freezable Water Content

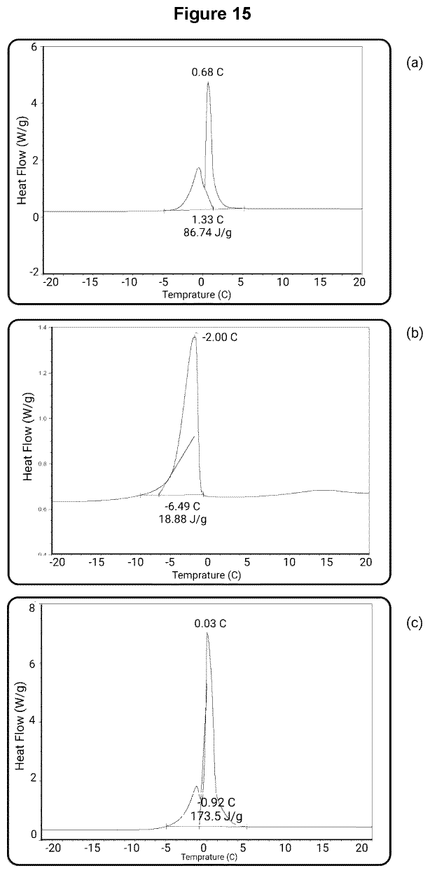

Table 6 reflects the stable water measured experimentally through the DSC device. FIG. 15 reflects the DSC scans of the neat and modified PES membranes. The addition of the UM-CB modifier to the PES membrane resulted in a nearly 17% increase in the stable water content while PES-UM-SB experienced a 19% increase in comparison with the neat PES membrane. The slight amount of stable water for the PES membrane could be due to the trapped water molecules in small pores or the interaction with the residual amount of pore formers in the PES membrane during the phase inversion process in the production line. The average freezing temperature (T_{freezing}) decreases as the modifications are added to the membrane (1.33° C., −6.49° C., and −0.92° C. for PES, PES-UM-CB, and PES-UM-SB respectively). In comparison with the PES, water associates with the UM-ZW surface of the membrane (through higher hydrogen bonding) and resists crystalizing and transforming to the solid phase. Accordingly, higher stability could be considered for the hydration layer of PES-UM-ZW membranes.

### Direct Attachment of GNDM for Zwitterionization

### Characterization of Neat PES and PES-directGNDM-ZW Membranes

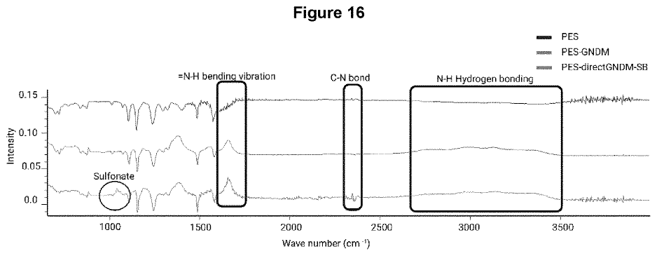

The chemical approach introduced to create a connection chain that includes GNDM uremic metabolite was successful with regards to adding a stable layer of water molecules. However, the modification resulted in higher surface roughness. It is crucial to avoid the high roughness patterns on polymeric membranes to prevent fouling in general applications of the membrane. More importantly, smoother surfaces could prevent the rapture of red blood cells in the dialysis process. Accordingly. A new chemical approach was used to immobilize GNDM directly on the PES membrane (PES-directGNDM-SB). FIG. 16 reflects the ATR-FTIR spectra of neat PES and functionalized PES-GNDM-SB membrane.

The characteristic peaks for the PES membrane are the weak asymmetric stretching vibration peak around 1340 and the symmetric vibration peak at 1134 cm⁻¹ [43, 24]. The sulfone characteristic ring could also locate in a different location (stretching vibrations 1242 cm⁻¹ and 1124 cm⁻¹ for PSF membrane [25]). The addition of amine functional groups to the PES membrane through aminolysis reaction was confirmed by the stretching peak for NH near 1636 cm⁻¹ and between 3300 cm⁻¹ to 3500 cm⁻¹. The two bands of NH appeared at 3390.53 cm⁻¹ and 3416.13 cm⁻¹, and the deformation band of NH₂ at 1618.92 cm⁻¹ [47]. The obvious peak between 2300 cm⁻¹ and 2400 cm⁻¹ represents the C—N bond which approves the chemical attachment of amine functional groups [48]. In addition, the peak that appeared between 2300 cm⁻¹ and 2400 cm⁻¹ represents the C—N bond, which approves the chemical attachment of amine functional groups [48]. The small peak between 1030 cm⁻¹ and 1050 cm⁻¹ reflects the sulfonate functional group as the end moiety of the sulfobetaine zwitterionic structure [40]. As both functional groups were identified successfully, the addition of SB to the PES using direct attachment of GNDM was confirmed.

### Grafting Amount and Equilibrium Water Content Measurement Through Gravimetry

Table 7 reflects the weight variation of PES membrane samples after being modified with GNDM and SB zwitterionic structure. The amount of modification layer adhered to the PES membrane after 93 μg. Other zwitterionization methodologies have also reported a range of a few hundred μg grafting weight change which agrees with the measurements presented here [40]. Adding hydrophilic structures would commonly result in a higher EWC percentage. The neat PES owned 43% EWC, while our modified PES-directGNDM-SB obtained a higher value of 51.63%. The extent of EWC growth could depend on the GA, the chemical structure of the modification layer, and the nature of the base membrane itself. The higher EWC reflects the higher hydrophilicity and the capacity of the modified membrane to keep water within its porous structure.

### Surface Roughness Patterns

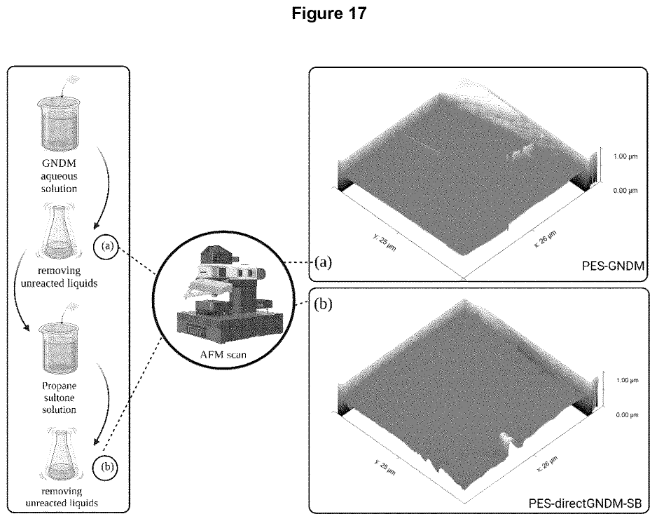

Table 8 reports the neat and functionalized membranes' roughness parameters. FIG. 17 illustrates the roughness patterns of the amine-functionalized using GNDM and PES-directGNDM-SB membrane. Our previous scans for neat PES membranes reflect a mean roughness (Sa) of 52.61 nm and RMS roughness (Sq) of 68.16 nm. After treating the membranes with GNDM solution, both parameters were decreased to 11.88 nm for Sa and 14.79 nm for Sq. The addition of the final negative moiety of sulfonate through the ring opening reaction increased the roughness parameters, i.e., 28.38 nm for Sa and 34.01 nm for Sq. the final roughness parameters were found to be less than the initial parameters of the untreated membrane. Accordingly, the approach could successfully decrease the roughness of the membrane.

### Surface Charge Measurement

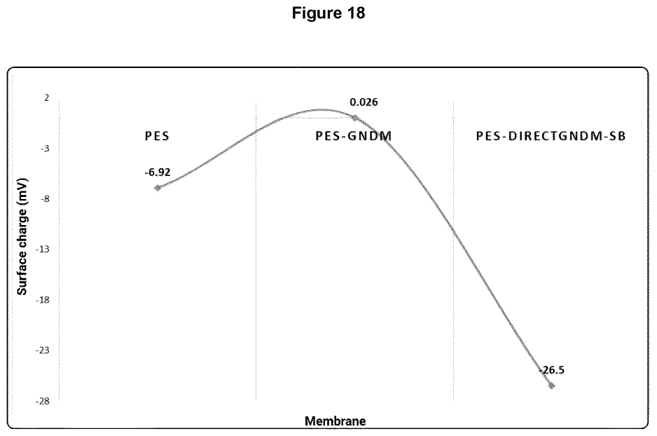

FIG. 18 reflects the changes in the surface charge of the PES membrane through the modification steps. The neat PES membrane owned a slightly negative surface charge equal to −6.92 mV. The negative nature of the PES membrane is due to its sulfone and ether functional groups. The addition of the amine active sites through aminolysis resulted in an increase in the surface charge to an amount slightly above zero. The ring opening reaction which was meant to add the final sulfonate moiety to the membrane resulted in a final negative surface charge of −26.5 mV.

### Non-Freezable Water Content

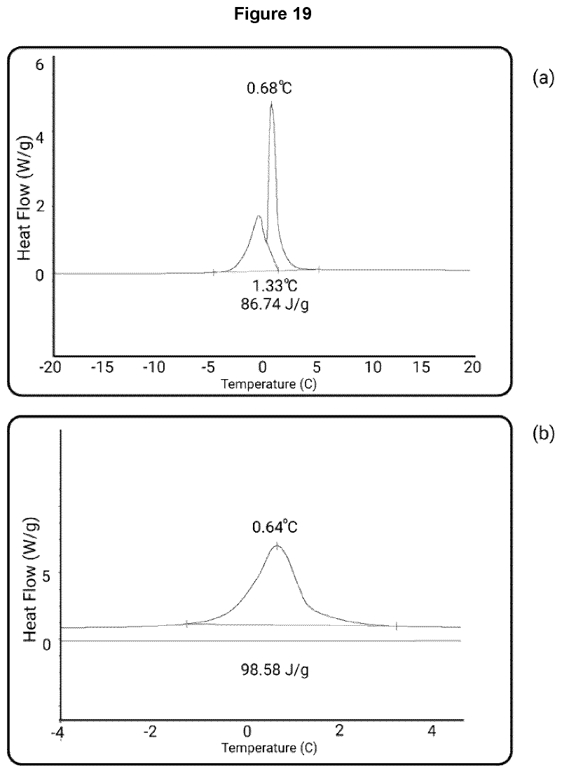

Table 9 reflects the stable non-freezable water content measured through the DSC. FIG. 19 illustrates the DSC scans of the neat and treated membranes. the unmodified PES membrane had 2.83% stable water that did not freeze in normal conditions. The addition of the modification layer resulted in a 16% growth in non-freezable water content. The association of water molecules with the ZW structures located on the modified surface could result in the stability of water molecules and accordingly their resistance to reorientation and formation of ice crystals. The increase in the stable water could result in higher surface protection and higher hemocompatibility [49, 50].

### Clinical Ex-Vivo Study

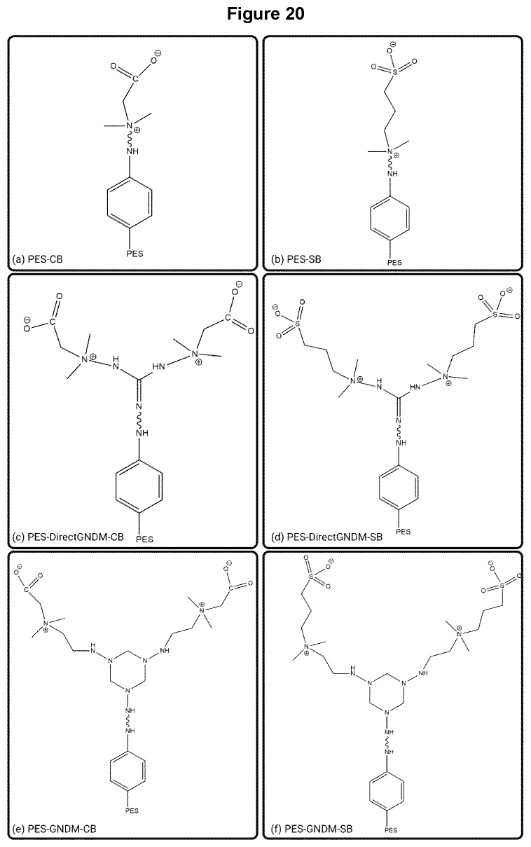

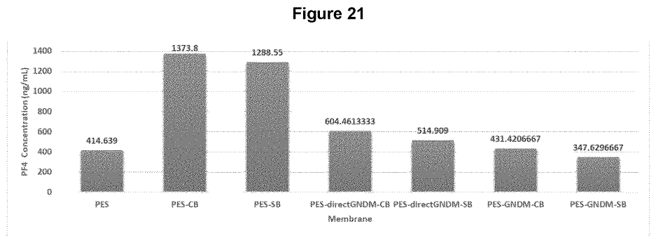

FIG. 20 shows different designed modifications to be attached to the PES membrane. The structures include either a simple zwitterionic structure or a uremic metabolite-mediated zwitterionic structure. FIG. 21 shows the PF4 concentration after incubating the neat PES and modified membrane samples with blood. The neat membrane resulted in a PF4 concentration of 414.63 ng/ml. The addition of different zwitterionic structures using different chemical scenarios resulted in both higher and lower PF4 concentrations. Within the first observation it could be said that, with the same middle chain connector, SB structures worked better than CB. PES-GNDM-SB could successfully reduce the PF4 concentration by 16% after the blood incubation, in comparison with all the neat and modified membranes. Indirect attachment of zwitterionic structures to the PES membrane resulted in more amine binding sites as reflected in FIG. 1. Despite the general idea of the presence of the negative moiety on the end chain of the connector, amine sites could attract negative carboxyl or sulfone structures and form more zwitterionic structures. Accordingly, a PES-GNDM-SB and PES-GNDM-CB owned higher zwitterionic content and lead to a better compatibility profile in comparison with the other membranes. Similar research on protein structures such as fibrinogen, shows SB has better performance in controlling the intermolecular interactions (leading to less protein adsorption on the modified surface), in comparison with CB [51]. Investigations on the water molecules' dipole distribution around CB and SB reflect a more intense interaction of water with CB [52]. Accordingly, SB could interact mildly with the water molecules resulting in a more moderate hydrogen bond profile and a hydration layer (that is stable enough to protect the blood constituents not to interact with the membrane and not strongly oriented so that it could provoke the proteins) leading to a higher hemocompatibility profile.

The effect of GNDM: The addition of GNDM, instead of DETA could to higher amine functionalization of the PES membranes. This could increase the chance of zwitterionization by creating more attachment sites for the negative moieties. Indirect attachment of GNDM involves two advantages for the modified membranes: (i) increasing the amine sites more than direct GNDM attachment, and (ii) creating a heterocyclic ring of carbon and nitrogen which could create more free volume on the surface and within the microstructure of the modification layer to absorb water. Cyclic structures with water-interactive atoms such as nitrogen could lead to higher hemocompatibility as a result of a higher stable water layer [53]. Accordingly, the PES-GNDM-ZW samples are more hemocompatible in comparison with the PES-directGNDM-ZW.

### Comparative Analysis

Table 10 demonstrates a comparison between the neat control PES sample and the 6 membranes modified with zwitterionic structures. Hemocompatibility of the membranes is a function of stable water within the structure of the hydrated membrane. The stability would increase with the increase in the number of hydrogen bonds. The addition of amine-containing GNDM resulted in higher stability of the water within its body as well as more moderated hydrogen bonding interaction (E/n) values in comparison with PES membranes. Computational studies reflect that the PES-GNDM-zwitterionic membranes have less water mobility in the vicinity of the membrane models. In addition, PES-GNDM-zwitterionic resulted in a lower membrane surface charge due to the higher content of nitrogen in PES-GNDM-ZW samples. The comparison roughness patterns reflect that PES-zwitterionic membranes have a smoother surface, which is more favorable for the hemocompatibility patterns. This is because rougher surfaces could potentially rupture blood cells and increase the hemolysis ratio. However, the stable hydration layer as well as higher equilibrium water content for PES-GNDM-zwitterionic, have the potential to prevent the increase in hemolysis factor. The BET investigations reflect that the pore structures are the pore volume could be more affected by the middle steps of the immobilization of GNDM on the membrane. Our measurements show that the sublayer prepared for the ziwtterionization (after DMPD treatment) owns an average pore size of 18.93 nm with a total pore volume of 0.16 cm3/g. The increase in the pore volume of the treated sublayer in comparison with the neat PES sample (0.06 cm3/g) reflects that the middle modifications have resulted in the formation of a new layer on the top of the PES sublayer. This is like interfacial polymerization where amine-based and aqueous-based monomers form a thin film on the top of the ultrafiltration sublayer to create a final thin film composite.

While the present disclosure has been described with reference to what are presently considered to be the preferred examples, it is to be understood that the application is not limited to the examples described herein. To the contrary, the present disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

TABLE 1
Elemental composition of PES neat and functionalized membranes

| | |
|---|---|
| Membrane | Elements (%) |

| samples | s | c | o | n | cl |
|---|---|---|---|---|---|
| PES | 5.90 | 72.8 | 20.41 | 0.92 | 0 |
| PES-UM-CB | 3.5 | 67.62 | 16.35 | 9.96 | 2.57 |
| PES-UM-SB | 7.13 | 71.23 | 16.35 | 5.29 | 0 |

TABLE 2
The grafting amount measured through gravimetry
for the neat and modified PES membranes

| Membranes | GA (mg) | STD | Error |
|---|---|---|---|
| PES-UM-SB | 6.13 | 0.74 | ±0.43 |
| PES-UM-CB | 5.70 | 0.87 | ±0.50 |

TABLE 3
Surface roughness parameters of neat and modified membranes

| Membrane sample | Sa | Sq |
|---|---|---|
| (size 10 μm × 10 μm) | (nm) | (nm) |
| PES | 52.61 | 68.16 |
| PES-UM-SB | 518.8 | 589.4 |
| PES-UM-CB | 371.3 | 456.2 |

TABLE 4
The equilibrium water content of
neat and UM-ZW-modified membranes

| Membrane | EWC (%) | STD | Error |
|---|---|---|---|
| PES | 43.13 | 2.98 | 1.72 |
| PES-UM-CB | 48.15 | 2.74 | 1.58 |
| PES- UM -SB | 52.44 | 3.34 | 1.93 |

TABLE 5
Surface area, pore volume, and pore size of the membranes

| | BET specific | | Pore | Pore size |
|---|---|---|---|---|
| | surface area | Pore volume | Diameter | range |
| Membranes | (m²/g) | (cm³/g) | (nm) | (nm) |
| PES | 78.10 | 0.06 | 1.45 | Higher than |
| | | | | 50 |
| PES-UM-CB | 9.23 | 0.08 | 17.31 | 2-50 |
| PES-UM-SB | 63.10 | 0.16 | 4.92 | 2-50 |

TABLE 6
Non-freezable content of neat and UM-ZW-modified membranes

| Membrane | Non-freezable water (%) |
|---|---|
| PES | 2.83 |
| PES-UM-CB | 19.68 |
| PES-UM-SB | 21.39 |

TABLE 7
The grafting amount and equilibrium water content measurement
for neat and functionalized PES membranes

Membranes

| | | PES-directGNDM- | | |
|---|---|---|---|---|
| | PES | SB | STD | Error |
| GA (mg) | N/A | 0.93 | 0.15 | ±0.09 |
| EWC (%) | 43.13 | 51.63 | 2.53 | ±1.46 |

TABLE 8
Roughness parameters of neat and modified membranes

| Membrane | Sa (nm) | Sq (nm) |
|---|---|---|
| PES | 52.61 | 68.16 |
| PES-GNDM | 11.88 | 14.79 |
| PES-directGNDM-SB | 28.38 | 34.01 |

TABLE 9
Non-freezable content of the neat and modified membranes

| Membrane | Non-freezable water (%) |
|---|---|
| PES | 2.83 |
| PES-directGNDM-SB | 18.90 |

TABLE 10
Comparison of membrane characteristics and clinical response of different membranes

| | | | | PES- | PES- | | |
|---|---|---|---|---|---|---|---|
| | | PES- | PES- | directGNDM- | directGNDM- | PES-GNDM- | PES- |
| Membrane | PES | CB | SB | CB | SB | CB | GNDM-SB |
| Non- | 2.83 | 12.85 | 16.28 | N/A | 18.9 | 19.68 | 21.39 |
| freezable | | | | | | | |
| water | | | | | | | |
| content (%) | | | | | | | |
| Hydrogen | −14.37 | −1.45 | −0.03 | N/A | −0.89 | −3.97 | −2.14 |
| bonding | | | | | | | |
| energy | | | | | | | |
| (kcal/mol) | | | | | | | |
| Hydrogen | 3 | 11 | 2 | N/A | 8 | 22 | 16 |
| bonding | | | | | | | |
| number | | | | | | | |
| E/n | −4.79 | −0.13 | −0.01 | N/A | −0.11 | −0.18 | −0.13 |
| RMV (%) | 100 | 82.47 | 78.88 | N/A | 71 | 60.78 | 55.03 |
| EWC (%) | 43.13 | 49.81 | 52.27 | N/A | 51.63 | 48.15 | 52.44 |
| Surface | −6.92 | −12.9 | −16.7 | N/A | −26.5 | −8.14 | −12.4 |
| charge (mV) | | | | | | | |
| Roughness | 52.61 | 6.3 | 7.7 | N/A | 28.38 | 518.8 | 371.3 |
| (Sa) | | | | | | | |
| PF4 (ng/mL) | 414.6 | 1373.8 | 1288.5 | 604.4 | 514.9 | 431.4 | 347.6 |

### REFERENCES

1. Ronco, C. and W. R. Clark, Haemodialysis membranes. Nature Reviews Nephrology, 2018: p. 1.
2. Mollahosseini, A., A. Abdelrasoul, and A. Shoker, A critical review of recent advances in hemodialysis membranes hemocompatibility and guidelines for future development. Materials Chemistry and Physics, 2020. 248: p. 122911.
3. Mollahosseini, A., A. Abdelrasoul, and A. Shoker, Challenges and Advances in Hemodialysis Membranes, in Advances in Membrane Technologies. 2020, IntechOpen. p. 151.
4. Mollahosseini, A. and A. Abdelrasoul, Introductory Chapter: An Overview of Recent Advances in Membrane Technologies. Advances in Membrane Technologies, 2020: p. 1.
5. Bowry, S. K., E. Gatti, and J. Vienken, Contribution of polysulfone membranes to the success of convective dialysis therapies, in High-Performance Membrane Dialyzers. 2011, Karger Publishers. p. 110-118.
6. Mollahosseini, A., A. Abdelrasoul, and A. Shoker, Latest advances in zwitterionic structures modified dialysis membranes. Materials Today Chemistry, 2020. 15: p. 100227.
7. Carpi, A., C. Donadio, and G. Tramonti, Progress in hemodialysis from emergent biotechnology to clinical practice. 2011.
8. Irfan, M. and A. Idris, Overview of PES biocompatible/hemodialysis membranes: PES-blood interactions and modification techniques. Materials Science and Engineering: C, 2015. 56: p. 574-592.
9. Zhao, J., et al., Biomimetic and bioinspired membranes: Preparation and application. Progress in Polymer Science, 2014. 39(9): p. 1668-1720.
10. Abdelrasoul, A., H. Doan, and A. Lohi, Fabrication of Biomimetic and Bioinspired Membranes, in Biomimetic and Bioinspired Membranes for New Frontiers in Sustainable Water Treatment Technology. 2017, IntechOpen.
11. Abdelrasoul, A., H. Doan, and A. Lohi, Recent Development in Aquaporin (AQP) Membrane Design, in Biomimetic and Bioinspired Membranes for New Frontiers in Sustainable Water Treatment Technology. 2017, IntechOpen.
12. Abdelrasoul, A., et al., Aquaporin-Based Biomimetic and Bioinspired Membranes for New Frontiers in Sustainable Water Treatment Technology: Approaches and Challenges. Polymer Science, Series A, 2018. 60(4): p. 429-450.
13. Ghalia, M. A. and A. Abdelrasoul, Synthesis and characterization of biopolymer-based mixed matrix membranes, in Biomass, Biopolymer-Based Materials, and Bioenergy. 2019, Elsevier. p. 123-134.
14. Abdelrasoul, A., H. Doan, and A. Lohi, Interactions between Aquaporin Proteins and Block Copolymer Matrixes, in Biomimetic and Bioinspired Membranes for New Frontiers in Sustainable Water Treatment Technology. 2017, IntechOpen.
15. Venault, A., et al., Surface self-assembled zwitterionization of poly (vinylidene fluoride) microfiltration membranes via hydrophobic-driven coating for improved blood compatibility. Journal of Membrane Science, 2014. 454: p. 253-263.
16. Nguyen, A. T., et al., Stable protein-repellent zwitterionic polymer brushes grafted from silicon nitride. Langmuir, 2011. 27(6): p. 2587-2594.
17. Chang, Y., et al., A highly stable non-biofouling surface with well-packed grafted zwitterionic polysulfobetaine for plasma protein repulsion. Langmuir, 2008. 24(10): p. 5453-5458.
18. Venault, A., et al., Engineering sterilization-resistant and fouling-resistant porous membranes by the vapor-induced phase separation process using a sulfobetaine methacrylamide amphiphilic derivative. Journal of Membrane Science, 2022. 658: p. 120760.
19. Kobayashi, S., et al., Poly (ω-methoxyalkyl acrylate) s: Nonthrombogenic polymer family with tunable protein adsorption. Biomacromolecules, 2017. 18(12): p. 4214-4223.
20. Sato, K., et al., The Relationship Between Water Structure and Blood Compatibility in Poly (2-methoxyethyl Acrylate)(PMEA) Analogues. Macromolecular bioscience, 2015. 15(9): p. 1296-1303.
21. Saadati, S., et al., Biocompatibility enhancement of hemodialysis membranes using a novel zwitterionic copolymer: Experimental, in situ synchrotron imaging, molecular docking, and clinical inflammatory biomarkers investigations. Materials Science and Engineering: C, 2020. 117: p. 111301.
22. Westphalen, H., et al., Case studies of clinical hemodialysis membranes: Influences of membrane morphology and biocompatibility on uremic blood-membrane interactions and inflammatory biomarkers. Scientific reports, 2020. 10(1): p. 14808.
23. Abdelrasoul, A., et al., Hemodialysis biocompatibility mathematical models to predict the inflammatory biomarkers released in dialysis patients based on hemodialysis membrane characteristics and clinical practices. Scientific reports, 2021. 11(1): p. 23080.
24. Mollahosseini, A., et al., A case study of poly (aryl ether sulfone) hemodialysis membrane interactions with human blood: molecular dynamics simulation and experimental analyses. Computer methods and programs in biomedicine, 2020. 197: p. 105742.
25. Weng, X.-D., et al., pH-responsive nanofiltration membranes containing carboxybetaine with tunable ion selectivity for charge-based separations. Journal of Membrane Science, 2016. 520: p. 294-302.
26. Ahmadijokani, F., et al., Amino-silane-grafted NH 2-MIL-53 (AI)/polyethersulfone mixed matrix membranes for CO 2/CH 4 separation. Dalton Transactions, 2019. 48(36): p. 13555-13566.
27. Xiang, T., et al., Surface hydrophilic modification of polyethersulfone membranes by surface-initiated ATRP with enhanced blood compatibility. Colloids and Surfaces B: Biointerfaces, 2013. 110: p. 15-21.
28. Kitano, H., Characterization of polymer materials based on structure analyses of vicinal water. Polymer Journal, 2016. 48(1): p. 15-24.
29. Ichikawa, K., et al., Fourier transform infrared study on the sorption of water to various kinds of polymer thin films. Journal of Polymer Science Part B: Polymer Physics, 2001. 39(18): p. 2175-2182.
30. Zhou, R., et al., Fabrication of antifouling membrane surface by poly (sulfobetaine methacrylate)/polydopamine co-deposition. Journal of Membrane Science, 2014. 466: p. 18-25.
31. P V, M. and A. Bhatt, Sulfobetaine-functionalized electrospun poly (ethylene-co-vinyl alcohol) membranes for blood filtration. Journal of Applied Polymer Science, 2019. 136(7): p. 47057.
32. Wang, J., et al., One-step synthesis of zwitterionic polyethersulfone ultrafiltration membranes crosslinked by BSA. Materials Letters, 2020. 261: p. 127007.
33. Al-Shaeli, M., et al., Highly fouling-resistant brominated poly (phenylene oxide) membranes using surface grafted diethylenetriamine. RSC advances, 2017. 7(59): p. 37324-37330.
34. Aghahosseini, H., M. R. Ranjbar, and A. Ramazani, Simple and Efficient Synthesis of Guanidine-Based Magnetic Nanocatalyst for the One-Pot, Four-Component Synthesis of Polyhydroquinolines in Water. ChemistrySelect, 2020. 5(28): p. 8415-8420.
35. Aghababaie, M., et al., Novel approaches to immobilize Candida rugosa lipase on nanocomposite membranes prepared by covalent attachment of magnetic nanoparticles on poly acrylonitrile membrane. RSC advances, 2018. 8(9): p. 4561-4570.
36. Wang, M., et al., Grafting of carboxybetaine brush onto cellulose membranes via surface-initiated ARGET-ATRP for improving blood compatibility. Colloids and Surfaces B: Biointerfaces, 2013. 103: p. 52-58.
37. Lin, Y, et al., Surface modification of PVA hydrogel membranes with carboxybetaine methacrylate via PET-RAFT for anti-fouling. Polymer, 2019. 162: p. 80-90.
38. Yuan, J., S. Lin, and J. Shen, Enhanced blood compatibility of polyurethane functionalized with sulfobetaine. Colloids and Surfaces B: Biointerfaces, 2008. 66(1): p. 90-95.
39. Zhao, Y-H., K.-H. Wee, and R. Bai, Highly hydrophilic and low-protein-fouling polypropylene membrane prepared by surface modification with sulfobetaine-based zwitterionic polymer through a combined surface polymerization method. Journal of Membrane Science, 2010. 362(1-2): p. 326-333.
40. Salimi, P., A. Aroujalian, and D. Iranshahi, Graft copolymerization of zwitterionic monomer on the polyethersulfone membrane surface by corona air plasma for separation of oily wastewater. Separation and Purification Technology, 2021. 258: p. 117939.
41. Li, Q., et al., Making polymeric membranes antifouling via “grafting from” polymerization of zwitterions. Journal of Applied Polymer Science, 2015. 132(21).
42. Li, Q., et al., Zwitterionic sulfobetaine-grafted poly (vinylidene fluoride) membrane surface with stably anti-protein-fouling performance via a two-step surface polymerization. Applied surface science, 2012. 258(10): p. 4707-4717.
43. Rahimpour, A., et al., Structural and performance properties of UV-assisted TiO2 deposited nano-composite PVDF/SPES membranes. Desalination, 2012. 285: p. 31-38.
44. Mahmoudian, M., P. G. Balkanloo, and E. Nozad, A facile method for dye and heavy metal elimination by pH sensitive acid activated montmorillonite/polyethersulfone nanocomposite membrane. Chinese Journal of Polymer Science, 2018. 36(1): p. 49-57.
45. Follain, N. g., et al., Water transport properties of plasma-modified commercial anion-exchange membrane for solid alkaline fuel cells. The Journal of Physical Chemistry C, 2012. 116(15): p. 8510-8522.
46. Kujawa, J., et al., Efficiency of grafting of Al2O3, TiO2 and ZrO2 powders by perfluoroalkylsilanes. Colloids and Surfaces A: Physicochemical and Engineering Aspects, 2013. 420: p. 64-73.
47. Seo, D.-W., et al., Preparation and characterization of sulfonated amine-poly (ether sulfone) s for proton exchange membrane fuel cell. International journal of hydrogen energy, 2010. 35(23): p. 13088-13095.
48. Lingegowda, D. C., et al., FTIR spectroscopic studies on Cleome gynandra-comparative analysis of functional group before and after extraction. Romanian Journal of Biophysics, 2012. 22(3-4): p. 137-143.
49. Bag, M. A. and L. M. Valenzuela, Impact of the hydration states of polymers on their hemocompatibility for medical applications: a review. International journal of molecular sciences, 2017. 18(8): p. 1422.
Mollahosseini, A. and A. Abdelrasoul, Novel Insights in Hemodialysis: Most Recent Theories on the Membrane Hemocompatibility Improvement. Biomedical Engineering Advances, 2022: p. 100034.
50. Zhang, Z., et al., Superlow fouling sulfobetaine and carboxybetaine polymers on glass slides. Langmuir, 2006. 22(24): p. 10072-10077.
51. Shao, Q., et al., Difference in hydration between carboxybetaine and sulfobetaine. The Journal of Physical Chemistry B, 2010. 114(49): p. 16625-16631.
52. Nishimura, S. n., et al., Chain-End Effect for Intermediate Water Formation of Poly (2-Methoxyethyl Acrylate). Organic Materials, 2021. 3(02): p. 214-220.
53. Nishimura, S. n., et al., Chain-End Effect for Intermediate Water Formation of Poly (2-Methoxyethyl Acrylate). Organic Materials, 2021. 3(02): p. 214-220

1. A hemodialysis membrane material having the following structure: 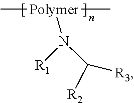
wherein,
n is an integer which represents the degree of polymerization and the number of repeating monomer units of the polymer and is between 1 and 1,000,000;
Polymer is a membrane material polymer;
R₁ is H, or (C₁-C₁₀)-alkyl;
R₂ is a moiety comprising a zwitterionic moiety; and
R₃ is H, (C₁-C₁₀)-alkyl or a moiety comprising a second zwitterionic moiety.

2. The hemodialysis membrane material of claim 1, wherein the polymer is

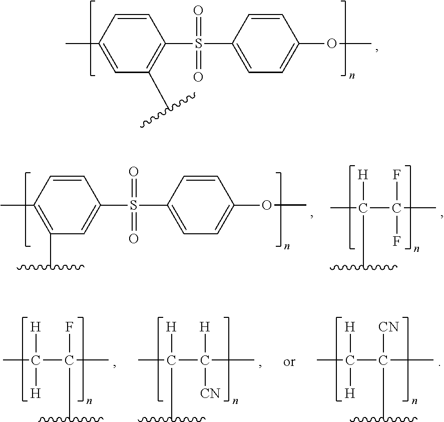

3. The hemodialysis membrane material of claim 1, wherein R₁ is H or (C₁-C₆)-alkyl.

4. The hemodialysis membrane material of claim 3, wherein R₁ is H or (C₁-C₃)-alkyl.

5. The hemodialysis membrane material of claim 4, wherein R₁ is H.

6. The hemodialysis membrane material of claim 1, wherein R₂ is —(C₀-C₁₀)-alkylene-(Z), wherein one or more of the carbon atoms in the (C₁-C₁₀)-alkylene is optionally replaced with NH, or N(C₁-C₆)-alkyl, and Z is a zwitterionic moiety.

7. The hemodialysis membrane material of claim 6, wherein R₂ is —(C₀-C₇)-alkylene-(Z), or R₂ is —(C₀-C₃)-alkylene-(Z).

8. The hemodialysis membrane material of claim 6, wherein R₂ is (C₇)-alkylene-(Z), wherein one or more of the carbon atoms in the (C₇)-alkylene is optionally replaced with NH, or N(C₁-C₆)-alkyl, and Z is a zwitterionic moiety.

9. The hemodialysis membrane material of claim 6, wherein R₂ is Z.

10. The hemodialysis membrane material of claim 1, wherein R₃ is H, (C₁-C₁₀)-alkyl, or —(C₀-C₁₀)-alkylene-(Z), wherein one or more of the carbon atoms in the (C₀-C₁₀)-alkylene is optionally replaced with NH, or N(C₁-C₆)-alkyl, and Z is a zwitterionic moiety.

11. The hemodialysis membrane material of claim 10, wherein R₃ is —(C₀-C₆)-alkylene-(Z), or R₃ is —(C₀-C₃)-alkylene-(Z).

12. The hemodialysis membrane material of claim 10, wherein R₃ is Z.

13. The hemodialysis membrane material of claim 6, wherein Z is 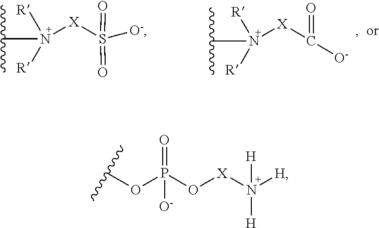
wherein X is independently or simultaneously —(C₀-C₁₀)-alkylene, or —(C₀-C₆)-alkylene or —(C₀-C₃)-alkylene; and R′ and R″ are independently or simultaneously —(C₁-C₁₀)-alkyl, or —(C₁-C₆)-alkyl or —(C₁-C₃)-alkyl or methyl.

14. The hemodialysis membrane material of claim 13, the zwitterionic moiety is

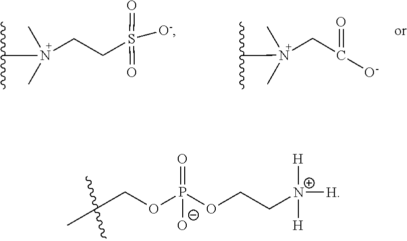

15. The hemodialysis membrane material of claim 1, wherein R₂ and R₃ is

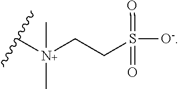

16. The hemodialysis membrane material of claim 1, wherein R₂ is 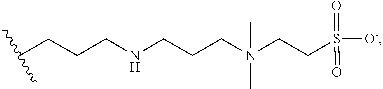
and R₃ is H.

17. The hemodialysis membrane material of claim 1, wherein the membrane material is

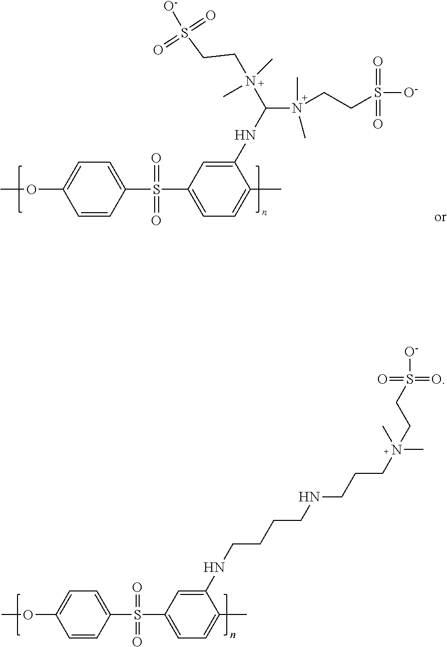

18. A hemodialysis membrane material having the following structure 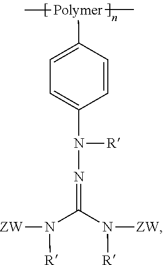
wherein Polymer is a membrane polymer material;
ZW is a zwitterionic moiety;
each R′ is independently or simultaneously H or (C₁-C₆)-alkyl; and
n is an integer which represents the degree of polymerization and the number of repeating monomer units of the polymer and is between 1 and 1,000,000.

19. The hemodialysis membrane material of claim 18, wherein the membrane material is

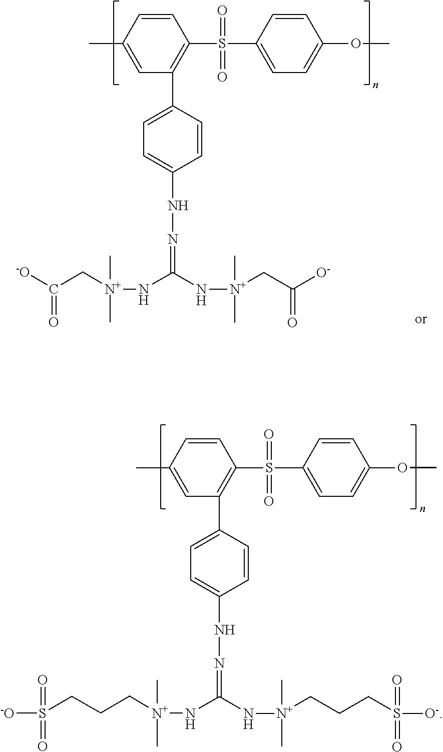

20. A hemodialysis membrane material having the following structure 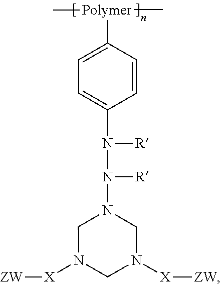
wherein Polymer is a membrane material polymer;
ZW is a zwitterionic moiety;
each R′ is independently or simultaneously H or (C₁-C₆)-alkyl;
each X is independently or simultaneously absent or (C₁-C₆-alkylene), in which one of the carbons in the alkylene group is replaced with nitrogen; and
n is an integer which represents the degree of polymerization and the number of repeating monomer units of the polymer and is between 1 and 1,000,000.

21. The hemodialysis membrane material of claim 18, wherein the membrane material is

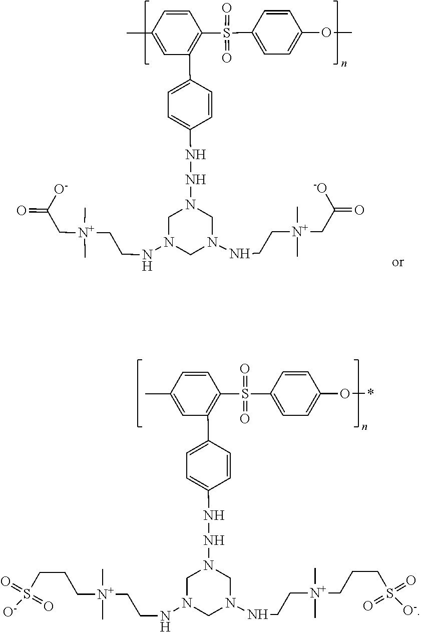

22. A method for hemodialysis or hemofiltration comprising contacting blood with a membrane comprising the hemodialysis membrane material of claim 1.
